(19) United States
(12) Patent Application Publication
(10) Pub. No.: US 2020/0228621 A1
(43) Pub. Date: Jul. 16, 2020

(54) SYSTEMS AND METHODS FOR INTEGRATING A TEMPORARY BUILDING NETWORK INTO A PERMANENT BUILDING NETWORK

(71) Applicant: Johnson Controls Technology Company, Auburn Hills, MI (US)

(72) Inventors: Timothy C. Gamroth, Dousman, WI (US); Nicholas J. Schaf, Hartland, WI (US); Robert C. Hall, Jr., Brown Deer, WI (US); Xin Zhang, Hartland, WI (US)

(21) Appl. No.: 16/740,279

(22) Filed: Jan. 10, 2020

Related U.S. Application Data
(60) Provisional application No. 62/791,720, filed on Jan. 11, 2019.

(51) Int. Cl. H04L 29/08; H04W 4/70; H04L 29/06; F24F 11/30

(52) U.S. Cl. CPC H04L 67/303; H04W 4/70; H04W 84/22; H04L 63/20; F24F 11/30; H04L 67/12

(57) ABSTRACT

A building network system for a building includes network devices forming a network for the building. Each network device includes a communications interface and a processing circuit. The communications interface is configured to communicate with other network devices of the multiple network devices. The processing circuit stores a first profile and a second profile. The first profile includes a first set of configuration settings that cause the network device to operate according to a first network topology when the first profile is active. The second profile includes a second set of configuration settings that cause the network device to operate according to a second network topology when the second profile is active. The processing circuit is configured to transition the network device from operating according to the first network topology to operating according to the second network topology by deactivating the first profile and activating the second profile.

### CROSS-REFERENCE TO RELATED PATENT APPLICATION

This application claims the benefit of and priority to U.S. Provisional Patent Application No. 62/791,720 filed Jan. 11, 2019, incorporated herein by reference in its entirety.

### BACKGROUND

The present disclosure relates generally to building networks for monitoring and controlling building equipment in or around a building. More specifically, the present disclosure relates to systems and methods for integrating a temporary building network into a permanent building network.

In a building, various pieces of building equipment (e.g., HVAC equipment, lighting equipment, security equipment, etc.) can communicate via a network within the building. The network may be a wired network, a wireless network, or a combination of both. In some embodiments, to properly operate, the pieces of building equipment must connect to the network in order to communicate data among each other or to other systems or devices connected to the network. When a building is being constructed, the building may not have the necessary network infrastructure to facilitate the network for the building equipment. In this regard, it may be difficult to test or install the pieces of building equipment when the building is being constructed.

### SUMMARY

One implementation of the present disclosure is a building network system for a building, according to some embodiments. In some embodiments, the system includes multiple network devices forming a network for the building. In some embodiments, each network device of the multiple network devices includes a communications interface and a processing circuit. In some embodiments, the communications is configured to communicate with other network devices of the multiple network devices. In some embodiments, the processing circuit stores a first profile and a second profile. In some embodiments, the first profile includes a first set of configuration settings that cause the network device to operate according to a first network topology when the first profile is active. In some embodiments, the second profile includes a second set of configuration settings that cause the network device to operate according to a second network topology when the second profile is active. In some embodiments, the processing circuit is configured to transition the network device from operating according to the first network topology to operating according to the second network topology by deactivating the first profile and activating the second profile.

In some embodiments, the communications interface is or includes a wireless radio configured to wirelessly communicate with the other network devices of the multiple network devices.

In some embodiments, the communications interface includes a wireless radio and an Ethernet interface and one or more of the multiple network devices are wireless-Ethernet hybrid devices.

In some embodiments, the multiple network devices are configured to form a wireless network for the building and transition between operating according to the first profile and operating according to the second profile automatically in response to a detected event or in response to a user command.

In some embodiments, the first network topology is a mesh network topology and the first set of configuration settings cause the network device to communicate with a cell tower using cellular communications when operating according to the first profile.

In some embodiments, the second set of configuration settings cause the network device to disable the cellular communications in response to transitioning to the second network topology and operating according to the second profile.

In some embodiments, at least one of the first profile or the second profile is a network profile including multiple device-specific profiles. In some embodiments, each of the device-specific profiles include a set of configuration settings for at least one of the multiple network devices. In some embodiments, the device-specific profiles include at least a first device-specific profile for a first network device of the multiple network devices and a second device-specific profile different from the first device-specific profile for a second network device of the multiple network devices.

In some embodiments, the multiple network devices are configured to use a first security policy when operating according to the first profile and a second security policy when operating according to the second profile. In some embodiments, the first security policy is a device manufacturer security policy and the second security policy is a security policy of an infrastructure network of the building.

In some embodiments, transitioning from operating according to the first network topology to operating according to the second network topology includes causing one or more network devices of the multiple network devices to operate as bridge devices between an infrastructure network of the building and the multiple network devices.

In some embodiments, the one or more network devices that function as bridge devices are configured to monitor a status of the infrastructure network of the building and cause the multiple network devices to transition back to operating according to the first profile in response to a detected failure of the infrastructure network.

In some embodiments, each network device of the multiple network devices stores multiple sets of device-specific configuration settings within at least one of the first profile or the second profile. In some embodiments, each set of the device-specific configuration settings corresponding to a different network device of the multiple network devices and are used by the corresponding network device when the first profile or the second profile is active.

In some embodiments, the first set of configuration settings cause one or more of the multiple network devices to operate as a dynamic host configuration protocol server or a domain name system server when the multiple network devices operate according to the first profile.

Another implementation of the present disclosure is a method for changing a network topology of a wireless network, according to some embodiments. In some embodiments, the method includes operating multiple network devices according to a first profile to form a stand-alone network for a building. In some embodiments, the method includes detecting a trigger at one of the multiple network devices to transition the multiple network devices to operate according to a second profile. In some embodiments, the method includes reconfiguring each of the multiple network devices to operate according to the second profile. In some embodiments, the multiple network devices form a converged network with an infrastructure network of the building when operating according to the second profile. In some embodiments, the method includes operating each of the multiple network devices according to the second profile.

In some embodiments, one or more of the multiple network devices connect to an external network outside the building when operating according to the first profile.

In some embodiments, at least one of the first profile or the second profile is a network profile including multiple device-specific profiles. In some embodiments, each of the device-specific profiles includes a set of configuration settings for at least one of the multiple network devices. In some embodiments, the device-specific profiles include at least a first device-specific profile for a first network device of the multiple network devices and a second device-specific profile different from the first device-specific profile for a second network device of the multiple network devices.

In some embodiments, the multiple network devices are configured to use a first security policy when operating according to the first profile and a second security policy when operating according to the second profile. In some embodiments, the first security policy is a device manufacturer security policy and the second security policy is a security policy of an infrastructure network of the building.

In some embodiments, reconfiguring each of the multiple network devices to operate according to the second profile includes causing one of more network devices of the multiple network devices to operate as bridge devices between an infrastructure network of the building and the multiple network devices.

In some embodiments, the method further includes monitoring a status of the infrastructure network of the building at the network devices that operate as bridge devices. In some embodiments, the method includes causing the multiple network devices to transition back to operating according to the first profile in response to a detected failure of the infrastructure network.

In some embodiments, each network device of the multiple network devices stores multiple sets of device-specific configuration settings within at least one of the first profile or the second profile. In some embodiments, each set of the device-specific configuration settings correspond to a different network device of the multiple network devices and is used by the corresponding network device when the first profile or the second profile is active.

Another implementation of the present disclosure is a method for changing a network topology of a network, according to some embodiments. In some embodiments, the method includes providing multiple network devices configured to operate according to a first profile and a second profile. In some embodiments, the method includes operating the multiple network devices according to the first profile to form a stand-alone network for a building. In some embodiments, the method includes transitioning the multiple network devices between the first profile and the second profile. In some embodiments, the method includes operating the multiple network devices according to the second profile to form a converged network with an infrastructure network of the building.

In some embodiments, one or more of the multiple network devices connect to an external network outside the building when operating according to the first profile.

In some embodiments, the multiple network devices are transitioned between the first profile and the second profile automatically in response to a detected event or in response to a user command.

In some embodiments, at least one of the first profile or the second profile is a network profile. In some embodiments, the network profile includes multiple device-specific profiles. In some embodiments, each device-specific profile includes a set of configuration settings for at least one of the multiple network devices. In some embodiments, the device-specific profiles include at least a first device-specific profile for a first network device of the multiple network devices and a second device-specific profile different from the first device-specific profile for a second network device of the multiple network devices.

In some embodiments, transitioning the multiple network devices from the first profile to the second profile includes causing one or more network devices of the multiple network devices to operate as bridge devices between the infrastructure network of the building and the multiple network devices.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a HVAC system, according to an exemplary embodiment.

FIG. 2 is a block diagram of a waterside system that may be used in conjunction with the building of FIG. 1, according to an exemplary embodiment.

FIG. 3 is a block diagram of an airside system that may be used in conjunction with the building of FIG. 1, according to an exemplary embodiment.

FIG. 4 is a block diagram of a service network in the building of FIG. 1, according to an exemplary embodiment.

FIG. 5 is a block diagram of a mesh service network in the building of FIG. 1, according to an exemplary embodiment.

FIG. 6 is a block diagram of a mesh service network in the building of FIG. 1 connecting building equipment together, according to an exemplary embodiment.

FIG. 7 is a block diagram of a mesh service network in the building of FIG. 1 connecting building equipment together and connecting to a backhaul Ethernet, according to an exemplary embodiment.

FIG. 8 is a block diagram of a network device of one of the service network of FIGS. 4-7 and 13-14 shown in greater detail, according to an exemplary embodiment.

FIG. 9 is a block diagram of a network device of one of the service network of FIGS. 4-7 and 13-14 shown in greater detail, according to an exemplary embodiment.

FIG. 10 is a block diagram of a network device of one of the service network of FIGS. 4-7 and 13-14 shown in greater detail, according to an exemplary embodiment.

FIG. 11 is a block diagram of a network device of one of the service network of FIGS. 4-7 and 13-14 shown in greater detail, according to an exemplary embodiment.

FIG. 12 is a block diagram of a network device of one of the service network of FIGS. 4-7 and 13-14 shown in greater detail, according to an exemplary embodiment.

FIG. 13 is a block diagram of a mesh service network in the building of FIG. 1 connecting building equipment together, according to an exemplary embodiment.

FIG. 14 is a block diagram of a mesh service network in the building of FIG. 1 connecting building equipment together, according to an exemplary embodiment.

FIG. 15 is a block diagram of a network device of one of the service network of FIGS. 4-7 and 13-14 shown in greater detail, according to an exemplary embodiment.

FIG. 16 is a block diagram of a network device of one of the service network of FIGS. 4-7 and 13-14 shown in greater detail, according to an exemplary embodiment.

FIG. 17 is a block diagram of a network device of one of the service network of FIGS. 4-7 and 13-14 shown in greater detail, according to an exemplary embodiment.

FIG. 18 is a flow diagram of a process for providing a piece of building equipment connectivity to an external network via one or more of the network devices of FIG. 7, according to an exemplary embodiment.

FIG. 19 is a block diagram of a temporary building network, according to some embodiments.

FIG. 20 is a block diagram of the temporary building network of FIG. 19 after being transitioned into a permanent building network.

FIG. 21 is a block diagram of the temporary building network of FIG. 19 after being transitioned into a permanent building network.

FIG. 22 is a flow diagram of a process for transitioning multiple node devices between a first network architecture and a second network architecture, according to some embodiments.

FIG. 23 is a state diagram of first profile and a second profile of one of multiple network devices, according to some embodiments.

### DETAILED DESCRIPTION

Overview

Referring generally to the FIGURES, a temporary or permanent service and/or installation network for installing building equipment in a building is shown, according to various exemplary embodiments. In many buildings, building equipment needs to be connected together in addition to being connected to external networks that may provide centralized services when the building equipment is being installed or tested. The building equipment may need to be connected to both on-premises networks (e.g., on premises cloud) and off-premises networks (off-premises cloud) during installation and/or testing. Unfortunately, for many buildings, during construction of the building and/or installation of the building equipment, this connectivity may be unavailable.

During a construction phase of a building, various building systems are brought on line (e.g., HVAC, BAS, lighting, access, etc.). Many of these systems rely on some portion of an IT infrastructure (typically IP based network elements) to complete the systems interconnected network. However, the IT systems are typically completed well after the other building operation systems have been installed and commissioned. As a result, temporary networks are installed to facilitate proper validation of the systems being installed and are removed/reworked when the IT network is in place. The present invention allows the same network hardware needed for permanent operations to be used during the construction phase, hence eliminating the need to remove and rework the network connections. The present invention provides a seamless method to convert a temporary building systems network to permanent part of the networking infrastructure when the permanent network is part of the IT infrastructure. Advantageously, the present invention removes the need to install a temporary network of switches, and/or access points (which would later have to be removed and rewired to use the permanent IT infrastructure

During installation of equipment in a building, various types of connectivity may be necessary for the equipment being installed. The connectivity may include equipment-to-equipment connectivity, equipment-to-the cloud connectivity, mobile device to the cloud, and mobile devices-to-equipment in the building. Equipment-to-equipment connectivity may be necessary since during installation, equipment may need to communicate with each other to verify proper operation before network infrastructure of a building is in place. In various embodiments, building equipment may need to transmit commands to each other for a technician to properly setup the equipment. Equipment-to-the cloud connectivity may be necessary since equipment may need to be connected to the cloud to perform optimized service operations (e.g., remote configuration, remote status reporting, receiving remote control operations, cloud service testing, access diagnostic tools, etc.).

Mobile device-to-cloud connectivity may be necessary since equipment installers and service individuals may need connectivity throughout the building for their mobile devices to access cloud services (e.g., the Internet) that are used to streamline installation and servicing (e.g., inspection and/or commissioning tools, configuration tools, remote equipment status and/or control, etc.). In various embodiments, mobile device-to-equipment connectivity may be necessary since installers and service individuals need connectivity throughout the building to directly monitor, configure, and control equipment via mobile devices (e.g., running diagnostics, equipment status and/or control, remote configuration changes, etc.) while installing and servicing even when cloud connections are not available.

To provide the necessary types of network connectivity for installing equipment in a building, a temporary service network may be necessary that enables connectivity for both equipment and for mobile devices of equipment installers and service individuals. Giving equipment installers and service individuals a temporary network may improve equipment installation and equipment servicing by reducing installation time and installation costs. In some embodiments, the temporary service network may be integrated into or become the permanent service network of the building. In some embodiments, the service network may be installed as a permanent network.

To provide a temporary service and installation network for a building, a plurality of network devices (e.g., portable temporary networking devices) may be deployed in a building that create a service network. The network devices can be deployed when a technician is servicing a building and needs a network or when a building is being built and there is no permanent network infrastructure. This service network may provide functionality for device-to-device communication, device-to-cloud communication, mobile device-to-device communication, and mobile device-to-cloud communication. The service network may be a wireless network that is ad-hoc, temporary (e.g., easily installed and removed as needed), and/or is a mesh network. In some embodiments, the service network may be integrated into the permanent infrastructure of the building or may be installed as a permanent network infrastructure. This may advantageously reduce the costs and time associated with removing the temporary service network and installing a new service network. Equipment and mobile devices can connect to the service network via a Wi-Fi or Ethernet connection. Further, everything connected to the service network can talk directly to each other, ad-hoc. In some embodiments, everything connected to the service network can communicate with the Internet via a cellular or Ethernet connection that one or more of the network devices includes. In this regard, one or more of the network devices can act as a gateway to the Internet.

The plurality of network devices can be deployed in a building to create a wireless mesh network between network devices as well as provide connections to equipment, mobile devices, and to the Internet. The service network can easily be created by placing these network devices in various places of a building. The plurality of network devices may automatically connect with each other and form the service network. In some embodiments, one or more of the plurality of network devices act as Wi-Fi access points. A technician can connect their smartphone to the Wi-Fi access point to access the Internet or directly access building equipment. Each of the network devices can also provide equipment and/or Internet connections. In some embodiments, a building may have enough network devices to generate a service network that allows communication such that all network devices can communicate with each other and all building equipment in the building can be communicatively coupled.

Each network device may connect to building equipment via an Ethernet, USB, or wireless connection. The network devices may also each provide a Wi-Fi access point for mobile devices to connect to. Further, each network device may enable mobile devices connected via the access point and building equipment connected via the Ethernet access to the Internet. Each network device may have access to the Internet itself and/or communicate to another network device to access the Internet via a network (e.g., ad hoc, mesh, etc.) of network devices. In some embodiments, one or more of the network devices has a wired Ethernet connection to the Internet. In various embodiments, one or more of the network devices have a USB connection that enables a cellular dongle to communicate via the Internet. In various embodiments, the cellular dongle is a cellular dongle offered by cellular carriers such as VERIZON®, AT&T®, SPRINT®, etc.

Each of the plurality of network devices may be powered via an AC power plug, a battery, a DC power plug, and/or a combination thereof. In various embodiments, the network device receives power directly from the equipment that it is connecting to the installation network. In some embodiments, a network device may include a battery and an AC power plug. In this regard, the network device can connect to the installation network even when not connected to an AC power outlet. This may allow an individual installing the network device to roam a building holding the network device. The network device may include an indicator that indicates whether the network device is within range of the service network (e.g., another network device). The indictor may activate whenever the wireless device can connect to another network device. This may allow a technician to create the service network since the technician can use the indicator to know when he has reached the wireless range limit of the network device.

When all of the equipment is installed and/or when networking infrastructure of the building is installed, the network devices can be disconnected from the equipment they are connected to and gathered up or may become a part of the permanent networking infrastructure of the building. This may effectively uninstall and remove the service network, or the services network may serve to be a part of, or the entirety of the permanent networking infrastructure of the building. If the network devices are uninstalled from the building and are not integrated into the permanent networking infrastructure of the building, they can be deployed at a different building and/or job site that can utilize the service network. For this reason, the temporary service network may reusable or it may be integrated into the permanent networking infrastructure of the building.

The installation network can be used in various cases when a building network infrastructure is not available and/or is not installed in the building. Servicing and inspecting fire alarm systems may be one possible use for the installation network. Fire alarm systems may require a technician to test all smoke detectors installed throughout a building periodically (e.g., once a year) to ensure proper operation. In some cases, the inspection requires two technicians. For example, one technician may need to be located at the panel to monitor the activation of the smoke detectors while the second technician roams the building injecting smoke into each of the smoke detectors.

The service network may give a single technician the ability to test the fire system without the help of a second technician. The fire panel may be connected to the service network such that activity of the fire panel (e.g., smoke detector activations, equipment resets, etc.) can be monitored, verified, and/or controlled from a technician's smartphone while the technician injects smoke into each of the smoke detectors of the building. Further, the technician can send the inspection results via the smartphone to a cloud server. The inspection results may be entered and/or annotated by the technician and may include smoke detector activation results, failure notes, photos of deficiencies, etc. This may result in a quicker inspection that may be less labor intensive in addition to providing a customer with a higher quality fire system inspection with proof that all of the devices of the fire system tested operate correctly. This may further confirm that the technician has actually done their job and has tested all of the smoke detectors instead of only a portion of the smoke detectors of a building.

In many cases, the fire panel does not itself connect to the Internet, especially in the case of legacy fire panels. In this regard, using the service network to provide the fire panel with Internet connectivity may be necessary. Even when fire panels do have the ability to connect to the Internet, there may be cases when the fire panel encounters obstacles that prevent the fire panel from connecting to the Internet. For example, the fire panel may be located in a basement where cinder blocks may block cellular signals. Further, a building may have spotty or no cellular data coverage where the fire panel is located. In these cases, the temporary service and installation network and the plurality of network devices may remedy the situation by providing the fire system and the fire panel with connectivity to the Internet.

Additionally, the ability for the service network to become part of the building networking infrastructure is advantageous for several reasons. It allows for a permanent building networking infrastructure that is wireless, and additional nodes to the building networking infrastructure can be easily added or removed without additional wiring. It also decreases the cost associated with installing and uninstalling a temporary service network, and then installing a separate permanent networking infrastructure of the building.

Systems and methods of the present disclosure relate to a network formed by multiple network devices, according to some embodiments. In some embodiments, the multiple network devices each include a wireless radio and a processing circuit. The wireless radio of each network device is configured to establish communication with other ones of the network devices that are within range of the wireless radio. In some embodiments, the processing circuit is configured to operate the wireless radio to establish wireless communication among the network devices. In some embodiments, the processing circuit is configured to store multiple profiles for the network devices. In some embodiments, the network devices are configured to operate according to the various profiles to form a network having a particular network topology corresponding to an active profile. For example, the network devices may each include a first profile that, when active, causes the network devices to establish a stand-alone mesh network. Likewise, the network devices may each include another profile that, when activated, causes the network devices to establish a converged network that is merged with an infrastructure network of a building that the network devices serve. The converged network may be a client/access point network or may be a bridged mesh network. For example, the network devices may include a second profile that, when activated, causes the network devices to establish a converged network with a client/access point network topology, or a third profile that, when activated, causes the network devices to establish a converged network with a bridged mesh network topology.

In some embodiments, the different profiles include profile-specific configuration settings and/or device-specific configuration settings. In some embodiments, the configuration settings may include profile or device specific security keys, profile or device specific service set identifiers (SSIDs), a setting indicating whether SSIDs should be broadcasted by the device, whether or not any of the network devices should operate as bridge devices, whether or not any of the network devices should operate as server devices, whether or not any of the network devices should have cellular connectivity, whether or not any of the network devices should use a spanning tree protocol, etc. In some embodiments, the device-specific configuration settings configure one or more of the network devices to function differently than the rest of the network devices. For example, when the network devices operate to form the stand-alone mesh network, one or more of the network devices may operate with device-specific configuration settings so that cellular connectivity is enabled. The network devices with cellular connectivity enabled may communicate with a nearby cell tower and network devices in the stand-alone mesh network to provide Internet connection to the network devices. In some embodiments, when the network devices operate to form the stand-alone mesh network, one or more of the network devices include configuration settings (e.g., device-specific configuration settings) so that some of the network devices operate as server devices (e.g., a dynamic host configuration protocol server, a domain name system server, etc.).

Likewise, when the network devices operate according to the first profile to form the standalone mesh network, the network devices use first security keys or a first security policy. In some embodiments, the first security policy is a policy set by a manufacturer of the network devices. In some embodiments, when the network devices operate according to the second or third profile to form the converged network (e.g., the client/access point network topology or the bridged mesh network topology) that is merged or connected with the infrastructure network of the building, the network devices use security keys or security policies set by an owner of the building (e.g., a same security policy as the infrastructure network of the building). In some embodiments, the security policy of the converged network is stricter than the security policy of the stand-alone mesh network.

When the network devices operate to form the bridged network (e.g., according to the third profile) or the client/access point network (e.g., according to the second profile), one or more of the network devices may be connected with the infrastructure network of the building. The network devices may communicate wirelessly with the network devices that are connected with the infrastructure network of the building in order to provide Internet connection to building equipment for control, adjustment of setpoints, operation, etc., of the building equipment.

In some embodiments, the topology of the network formed by the network devices may be changed (e.g., between a stand-alone mesh network topology, a client/access point network topology, or a bridged mesh network topology) by transitioning the network devices between the various profiles. For example, the network devices may be installed by a technician as a temporary network for the building (e.g., before the infrastructure network of the building is even installed) and operated according to the first profile to establish a stand-alone mesh network. Once it is desired for the network topology to be changed, the network devices may be transitioned to operate according to the second or third profile to form the converged network with the infrastructure network of the building.

The changeover or transition of the network topology may be initiated automatically or by a user command. For example, a technician may initiate the changeover or transition of the network topology by updating configuration settings of one of the network devices. In some embodiments, the technician may initiate the changeover or transition of the network topology by activating the second or third profiles of the one of the devices. In some embodiments, each of the network devices include the various configuration settings and profiles, but only operate according to the profiles when the profiles are activated. For example, each of the network devices may store the first, second, and third profiles, but only activate one of the profiles at a time (e.g., the first profile) while keeping the other profiles stored in memory but de-activated (e.g., the second and third profiles). In some embodiments, each of the network devices store placeholders for the various configuration settings of each of the profiles (e.g., the second and third profiles) even when the profiles are de-activated. In some embodiments, the placeholders are overwritten with values when the profiles are activated. The values for the configuration settings may be written or provided by the technician when the changeover is initiated. In some embodiments, the technician may provide or write configuration settings for the activated profile at one of the network devices. The network device at which the technician initiates the changeover may forward configuration settings for the other network devices, an indication to activate a particular profile, etc. In some embodiments, the network devices store their own configuration settings for the various profiles. In some embodiments, the network devices receive configuration settings for the various profiles from the network device at which the technician initiates the changeover (e.g., directly from the network device at which the technician initiates the changeover, or indirectly through other network devices).

In some embodiments, the changeover is initiated automatically in response to an event. For example, when the network devices operate according to the third profile to form a bridged mesh network that is converged with the infrastructure network of the building, one or more of the network devices may operate as bridge devices with the infrastructure network of the building. These network devices may monitor a status of the infrastructure network in real-time. If the infrastructure network fails (e.g., loses internet connectivity) or fails for a predetermined amount of time (e.g., loses internet connectivity for a predetermined amount of time), the bridge devices may initiate a changeover or a transition of the network devices to the stand-alone mesh network topology (e.g., initiate the network devices to operate according to the first profile). In this way, the network devices may operate as a converged or permanent network with the infrastructure network of the building when the infrastructure network of the building provides internet connectivity, but default to a stand-alone mesh network topology (e.g., operate according to the first profile) in response to the infrastructure network of the building failing.

In some embodiments, the changeover or the transition between any of the network topologies described herein is initiated by the changing of a network profile of any of the network devices. In some embodiments, the changeover or the transition of the network devices to form any of the network topologies described herein is initiated by an external tool (e.g., an external system, server, device, a remotely positioned device, etc.). In some embodiments, the transition or changeover of the network devices to form any of the network topologies described herein is initiated by using a mirroring technique. For example, a network profile of one or more of the network devices may be changed by a technician. This change may then be mirrored to the other network devices.

In some embodiments, the changeover is initiated by detection of a trigger. A trigger may be any event, external network detection, command received from an external network, sensor feedback, user command, presence of absence of an external network, etc., detected at any of the network devices.

### Building Management System and HVAC System

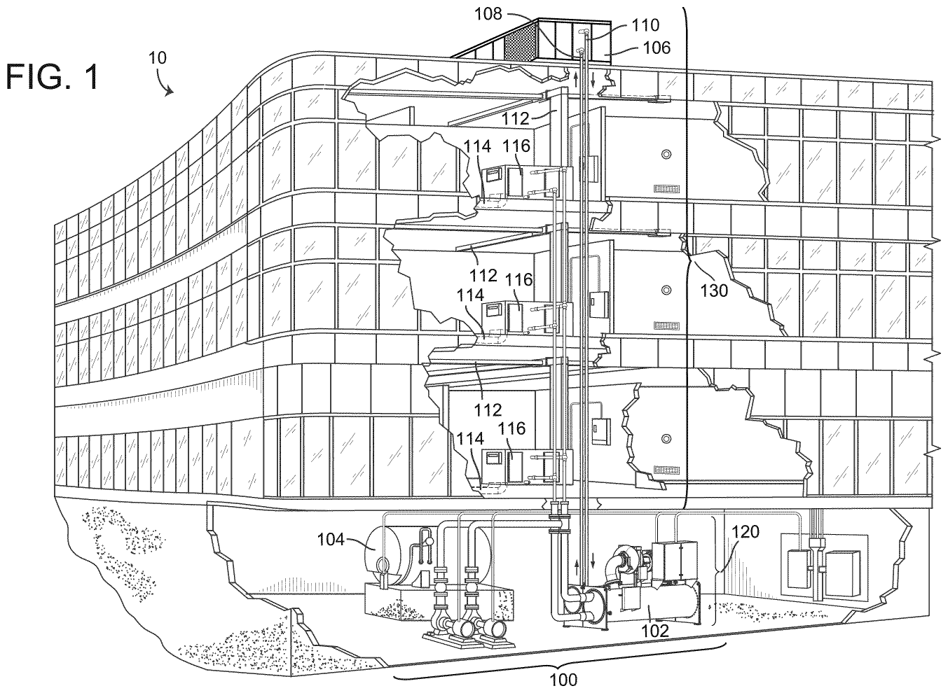

Referring now to FIGS. 1-3, an exemplary building management system (BMS) and HVAC system in which the systems and methods of the present invention can be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

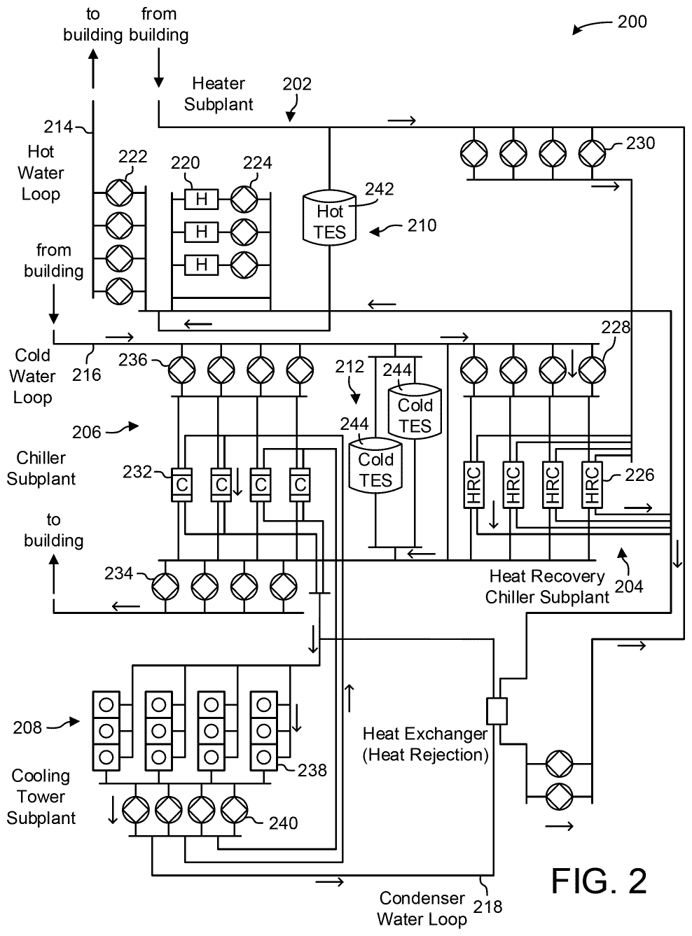

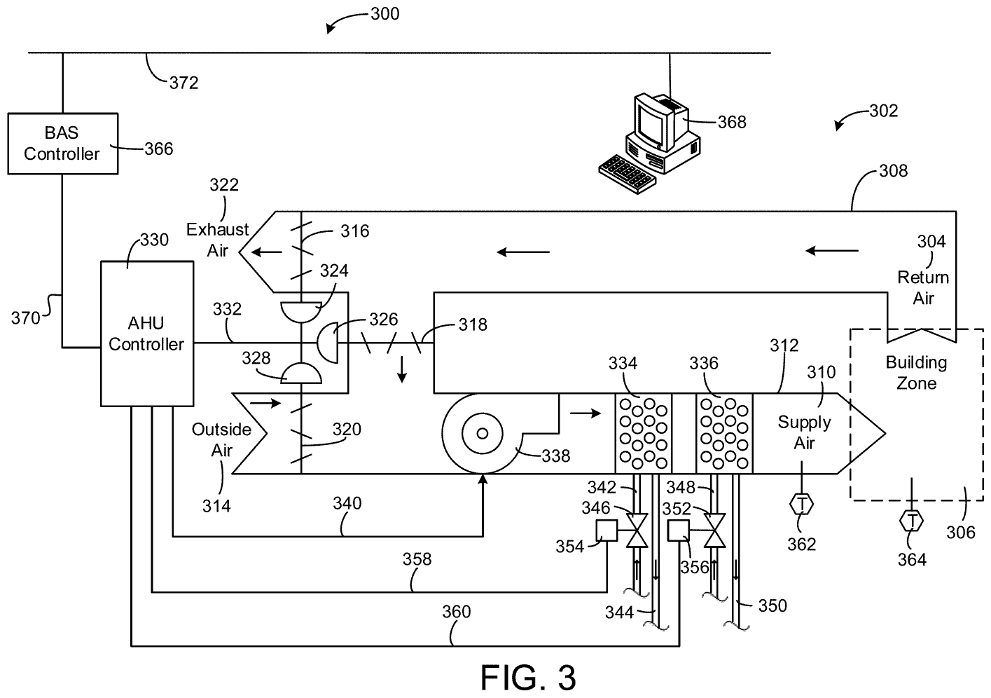

The BMS that serves building 10 includes an HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

Referring now to FIG. 2, a block diagram of a waterside system 200 is shown, according to an exemplary embodiment. In various embodiments, waterside system 200 can supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and can operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 can absorb heat from the cold water in chiller subplant 206 and reject the absorbed heat in cooling tower subplant 208 or transfer the absorbed heat to hot water loop 214. Hot TES subplant 210 and cold TES subplant 212 can store hot and cold thermal energy, respectively, for subsequent use.

Hot water loop 214 and cold water loop 216 can deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve the thermal energy loads. In other embodiments, subplants 202-212 can provide heating and/or cooling directly to the building or campus without requiring an intermediate heat transfer fluid. These and other variations to waterside system 200 are within the teachings of the present invention.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 can also include one or more pumps or valves configured to control the flow rate of the hot water into or out of hot TES tank 242. Cold TES subplant 212 is shown to include cold TES tanks 244 configured to store the cold water for later use. Cold TES subplant 212 can also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 can supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 can operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 can receive return air 304 from building zone 306 via return air duct 308 and can deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 can communicate with an AHU controller 330 via a communications link 332. Actuators 324-328 can receive control signals from AHU controller 330 and can provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 can communicate with fan 338 via communications link 340 to control a flow rate of supply air 310. In some embodiments, AHU controller 330 controls an amount of heating or cooling applied to supply air 310 by modulating a speed of fan 338.

Cooling coil 334 can receive a chilled fluid from waterside system 200 (e.g., from cold water loop 216) via piping 342 and can return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 can receive a heated fluid from waterside system 200 (e.g., from hot water loop 214) via piping 348 and can return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 can communicate with AHU controller 330 via communications links 358-360. Actuators 354-356 can receive control signals from AHU controller 330 and can provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 can also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 can control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 can communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 can provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 can communicate with BMS controller 366 and/or AHU controller 330 via communications link 372.

### Temporary Network and Network Devices

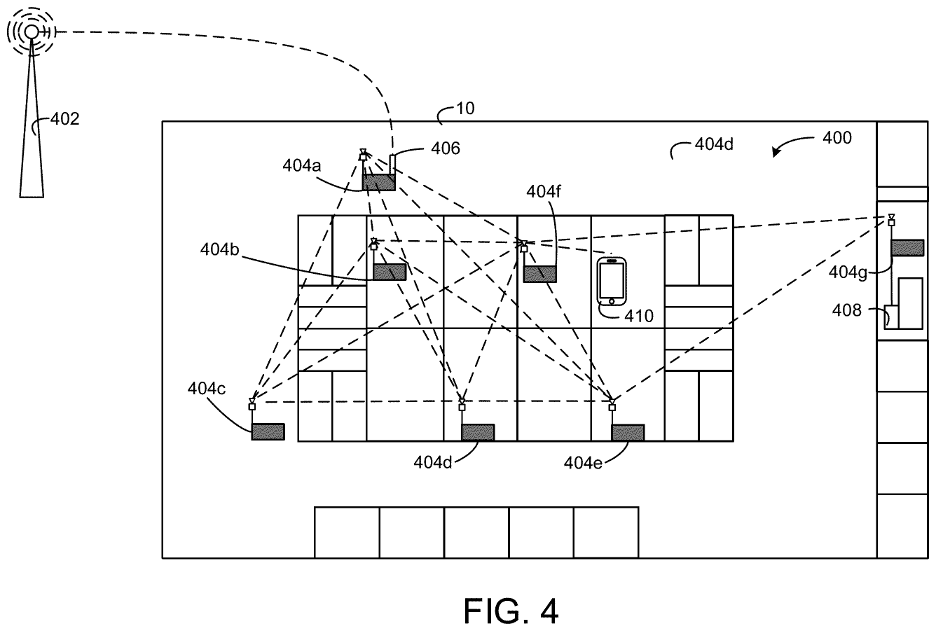

Referring now to FIG. 4, a block diagram of a service network 400 is shown, according to an exemplary embodiment. FIG. 4 is shown to include a cell tower 402, network devices 404a-e, system manager 412, building equipment 408, and user device 410. Network devices 404a-e and system manager 412 form network 400. Network 400 may be one or a combination of networks such as Wi-Fi, Bluetooth, ZigBee, LoRa, and/or any other wireless network. Network 400 may be an ad hoc network (e.g., MANET, VANET, SPANET, iMANET) and/or a mesh network and/or may enables network devices 404a-e to communicate ad-hoc.

As can be seen in FIG. 4, each of the network devices 404a-g communicate wirelessly ad-hoc with each other providing connection between building equipment 408 and cell tower 402. In FIG. 4, a building 10 is shown. The left side of building 10 may have cellular coverage by cell tower 402, however, the right side of building 10, where building equipment 408 is located, may have poor and/or no connection to cellular tower 402. Network devices 404a-g may include one network device that communicates with cell tower 402, network device 404a. In some embodiments, network device 404a may operate as a gateway for network devices 404a-g to communicate with the Internet. In some embodiments, network device 404a may act as a system manager. Network device 404a may have connection to the Internet via cell tower 402. Based on communications between network devices 404a-g, network devices 404a-g may all have access to the Internet via network device 404a. Network devices 404a-g may communicate to each other via Wi-Fi, ZigBee, LoRa, and/or any other wireless protocol or combination thereof. Further, building equipment 408 may have connection to the Internet via network device 404g while network device 404g may have connection to the Internet via network device 404a.

Network devices 404a-g may automatically form a mesh network. For example, an installer may place network device 404a in building 10. Then, the installer may place network device 404b in building 10. Network device 404b can be configured to automatically form a mesh network with network device 404a. Similarly, an installer may place network device 404c in building 10 which is configured to automatically form a mesh network with network device 404b. The same process occurs when an installer places network devices 404d, 404e, 404f and 404g in building 10.

Network device 404a is shown to include cellular dongle 406. Cellular dongle 406 may be any cellular dongle that is configured to communicate with cellular tower 402. In some embodiments, cellular dongle communicates to cell tower 402 via a 2G network, a 3G network, a LTE network, and/or any other kind of cellular network. Cellular dongle 406 may be a USB device that can be plugged into network device 404a, providing network device 404a with Internet access.

Cellular tower 402 may be any kind of cellular tower that communicates with smartphones and/or cellular dongles e.g., cellular dongle 406. Cellular tower 402 may be a cell tower owned, operated, and/or leased by network service providers such as VERIZON®, AT&T®, SPRINT®, etc. The cellular tower 402 may provide access to a wide area network (WAN) such as the Internet. By connecting to cellular tower, network device 404a can be configured to connect to the Internet and provide network devices 404b-g access to the Internet.

User device 410 can be any type of user computing device. User device 410 can be a smartphone, a laptop, a technician device, tablet device, and/or any other computing device. Each of network devices 404a-e may act as a Wi-Fi access point for user device 410. In this regard, user device 410 can connect via Wi-Fi to one of network devices 404a-e (in FIG. 4 user device 410 is shown to be connected to network device 404d). User device 410 may have Internet connection via the access point since the network device providing user device 410 with the Wi-Fi connection may communicate to cellular tower 402 directly and/or through other network devices. In FIG. 4, user device 410 is shown to be connected via Wi-Fi to network device 404d. Network device 404d may communicate with network device 404c, network device 404b, and network device 404a to access the Internet and/or another network provided by cellular tower 402.

Building equipment 408 may be any kind of HVAC, security, and/or fire prevention device and/or system. In some embodiments, building equipment 408 is one and/or a combination of AHU 106, VAVs 116, boiler 104, chiller 102, a thermostat, and/or any other building HVAC device. In some embodiments, building equipment 408 is a fire detector, a fire panel, a security camera, a security panel, and/or any other piece of building equipment. Building equipment 408 is shown to be connected to network device 404g. In some embodiments, building equipment 408 is connected to network device 404g via an Ethernet LAN connection. In various embodiments, network device 404g acts as a Wi-Fi access point and building equipment 408 connects to network device 404g via Wi-Fi.

In some embodiments, building equipment 408 can be a fire panel for building 10 that a technician can connect to the Internet via network 400. The technician may be any inspector or other individual who may want to verify the operation of the fire panel. The technician may have a cellular dongle (e.g., cellular dongle 406) that the technician can plug into network device 404a. The technician may move network device 404a to various points in building 10 to achieve a strong connection between cellular tower 402 and network device 404a. In some embodiments, network device 404a may support various network dongles (e.g., various network carriers) so that the technician can utilize various cellular dongles based on the geographic location of building 10 and the coverage offered by each of the network provides in the geographic location of building 10.

The technician may place another network device (e.g., network device 404b) within range of network device 404a. The technician can place another network device closer to the fire panel than network device 404a while still being within range of network device 404a. Network device 404b may automatically connect to network device 404a. The technician can repeat this process of placing network devices until a path from the fire panel (e.g., building equipment 408) to cellular tower 402 is established. In some embodiments, the last network device, network device 404e may connect to the fire panel via Wi-Fi and/or via an Ethernet cable. In this regard, network devices may be placed in building 10 until a path is formed that network device 404g can connect to the fire panel via at least one of Wi-Fi and/or Ethernet. In various embodiments, a technician device is connected to the fire panel and this technician device may communicate between the fire panel and the network device 404g. This technician device may be utilized in testing building equipment 408. In some embodiments, the technician device connects to the Internet through network devices 404a-g.

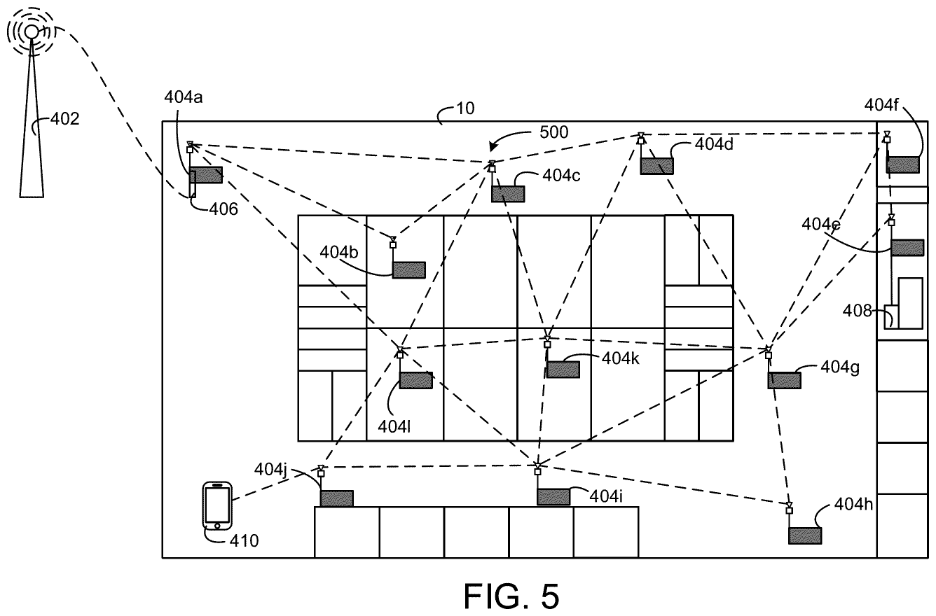

Referring now to FIG. 5, network devices 404a-1 communicating in a mesh in building 10 are shown, according to an exemplary embodiment. Network devices 404a-1 are shown to communicate in a mesh network 500 in building 10. Every device connected to mesh network 500 may be configured to communicate with every other device connected to mesh network 500, further, each device may be able to communicate to the Internet via mesh network 500. The mesh network may be a Wi-Fi mesh network, a ZigBee mesh network, a LoRa mesh network, and/or any other mesh network or combination thereof. Mesh network 500 and network 400 may be the same and/or similar networks. Mesh network 500 may provide a plurality of data packet routes through mesh network 500 between the various devices of mesh network 500. For example, building equipment 408 may have access to cellular tower 402 and/or the Internet via network device 404e, 404g, 404i, 4041, and 404a. However, if this path to cellular tower 402 is unavailable or is not a fast route for transmitting and/or receiving data, network device 404e may communicate via network device 404g, 404k, 4041, 404b, and 404a. There are multiple paths that may be utilized to transmit data to building equipment 408a from cellular tower 402 and/or from building equipment 408 to cellular tower 402.

In some embodiments, each and/or some of network devices 404a-1 act as wireless access points. In this regard, in FIG. 5, network devices 404a-1 cover the majority of building 10, adding the availability of a wireless network for mobile phones throughout building 10. For example, user device 410 is shown to communicate with network device 404j. In some embodiments, network devices 404a-1 may be placed at various locations in building 10 that may have poor cellular connection with cell tower 402. This may allow a technician access to cellular tower 402 via mesh network 500. This may be useful for a technician when the technician is servicing equipment in building 10. In one example, the mesh network 500 may be useful in the case of testing various fire detectors in building 10. A technician inspecting the fire detectors may need Internet connection on the phone of the technician so that the technician can monitor the response of a fire panel to injecting smoke into various smoke detectors. In various embodiments, the technician may place network devices 404a-1 in building 10 before beginning an inspection and can remove network devices 404a-1 from building 10 and reuse the network devices in a different building.

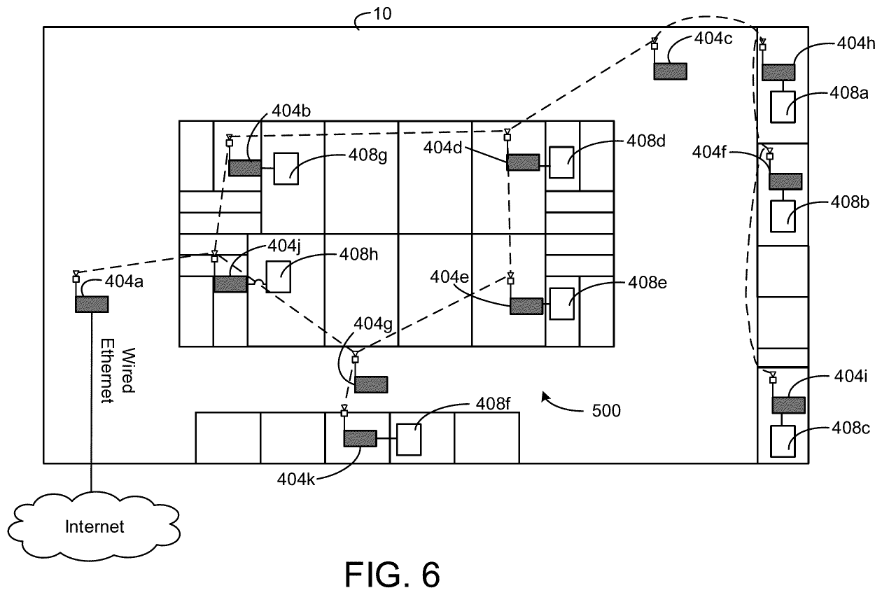

Referring now to FIG. 6, a block diagram of a mesh network 500 in building 10 connecting building equipment together is shown, according to an exemplary embodiment. Mesh network 500 is shown to connect building equipment 408a-h. In various embodiments, mesh network 500 may include one network device that has access to the Internet. In various embodiments, there are no building equipment that have access to the Internet. In FIG. 6, network device 404a is shown to be connected to the Internet via a wired Ethernet connection. In this regard, mesh network 500 may be configured to extend an existing Internet connection of building 10 to other areas of building 10.

Each of building equipment 408a-e can communicate via mesh network 500. In some embodiments, allowing building equipment 408a-e to communicate with each other via mesh network 500, allowing a technician to install, test, debug, configure, and setup building equipment 408a-e even when there is no permanent network infrastructure installed in building 10. For example, building equipment 408g may be a controller that generates control signals for building equipment 408h. When building 10 includes a permanent and/or temporary network infrastructure, building equipment 408g can be configured to send the control signals to building equipment 408h via the permanent and/or temporary network infrastructure. In some embodiments, the permanent and/or temporary network infrastructure may be mesh network 500 (or mesh network 400). In some embodiments, the mesh network 500 is integrated into the permanent network infrastructure. In some embodiments, the mesh network 500 is the permanent network infrastructure, providing a permanent network infrastructure between building equipment 408 that is wireless. However, during the construction of building 10, there may be no network infrastructure in building 10. In this case, building equipment 408a may connect to network device 404h, building equipment 408b may connect to network device 404f, building equipment 408c may connect to network device 404i, building equipment 408d may connect to network device 404d, building equipment 408e may connect to network device 404e, building equipment 408f may connect to network device 404k, building equipment 408g may connect to network device 404b, and building equipment 408h may connect to network device 404j. Network devices 404c and 404g may communicably connect various network devices 404 which are out of range of each other according to some embodiments and may provide a temporary network communication. Network device 404a may provide a direct wired connection to the internet in some embodiments. In some embodiments, network device 404a may include control algorithms to control the operation of building equipment 408a-h.

In FIG. 6, a network device of network devices 404a-k is connected to each piece of building equipment, building equipment 408a-h. Each network device 404a-k may be connected to a particular building equipment 408a-h via Wi-Fi, a Wi-Fi access point provided by each of the network devices, or a wired connection to the network devices 404a-k, such as Ethernet or USB. Each network device may connect the building equipment together allowing them to communicate, may connect the building equipment to the Internet, and may further provide a Wi-Fi access point for a smartphone and/or other Wi-Fi enabled device. In various embodiments, building equipment 408a-k may connect to their respective network devices via an Ethernet or USB connection. Each of network devices 404a-k may automatically form mesh network 500. In various embodiments, a technician can deploy any number of network devices, in some cases, to bridge the any communications gap between network devices that are too far apart to connect.

Once all the networking devices have created a single service network all equipment on the service network can communicate with each other allowing full operation. The installer's smartphone can also connect to the service network via the Wi-Fi access point on any of the network devices. This allows the installer convenient access to equipment status, monitor equipment, control, and configuration to aid in operational testing, debugging, and correction of issues. The installer can also increase the Wi-Fi coverage of the site by using additional network devices. Once the building network infrastructure is in place and operational, the network devices 404a-k can be removed, integrated into the permanent network infrastructure or become the permanent network infrastructure. In some embodiments, the network devices 404a-k may be installed as the permanent network infrastructure. This may benefit an installer since the building equipment 408a-h may be in an operational state and any faults diagnosed and resolved before the permanent network infrastructure of building 10 is installed. Additionally, if the mesh network 500 is integrated into the permanent network infrastructure or becomes the permanent network infrastructure, the costs associated with installing a new network infrastructure and removing the mesh network 500 are reduced. Additionally, the permanent network infrastructure is a wireless network infrastructure which is advantageous since it reduces the need to hardwire mesh network 500 and provides the ability to easily add and remove or replace network devices 404. In some embodiments, network device 404a may serve as system manager. In some embodiments, system manager may control mesh network 500 and control the operation of the building equipment 408. A user may connect to the network device 404a by connecting to any of the network devices 404 in the mesh network 500 via computing device, and may be able to adjust the operation of the network 500 and the building equipment 408.

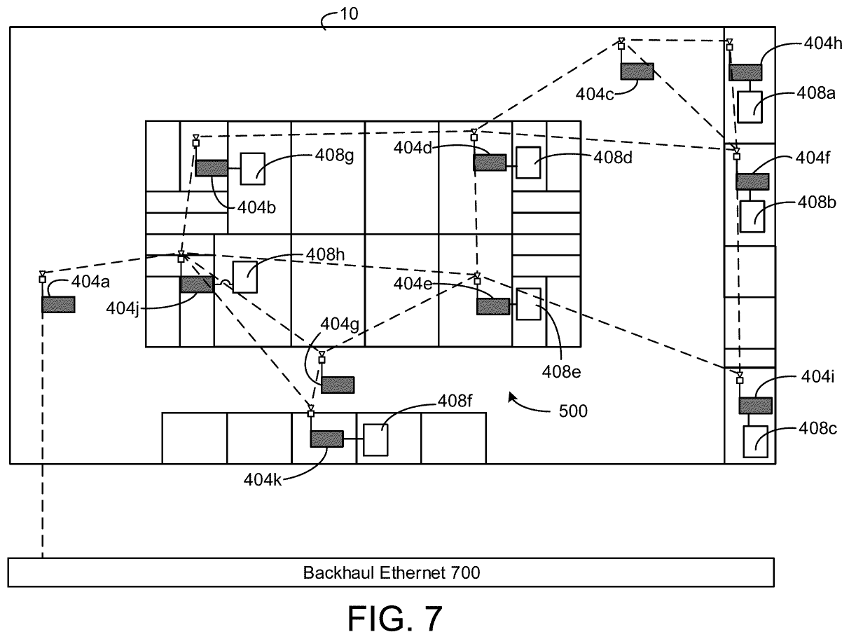

Referring now to FIG. 7, the mesh network 500 is shown integrated into the permanent network infrastructure according to some embodiments. Network devices 404a-404k are shown connected to backhaul Ethernet 700. Network devices 404a-k may communicate with the backhaul Ethernet 700 via hardwire, or via a wireless radio. In some embodiments, the backhaul Ethernet 700 may be accessed by the permanent network infrastructure. In some embodiments, the network devices 404a-k each directly connect to the backhaul Ethernet. Network devices 404 may connect to the backhaul Ethernet and may also communicate with each other wirelessly according to some embodiments. The backhaul Ethernet 700 is part of the building infrastructure in some embodiments. In some embodiments, one of the network devices (e.g., network device 404a) may act as the system manager and may connect the mesh network 500 to the backhaul Ethernet 700 via a wired Ethernet connection while the other network devices 404 connect wirelessly to network device 404a. Backhaul Ethernet 700 may directly connect to another network infrastructure according to some embodiments. The network infrastructure which backhaul Ethernet 700 connects to may be a permanent network infrastructure, according to some embodiments.

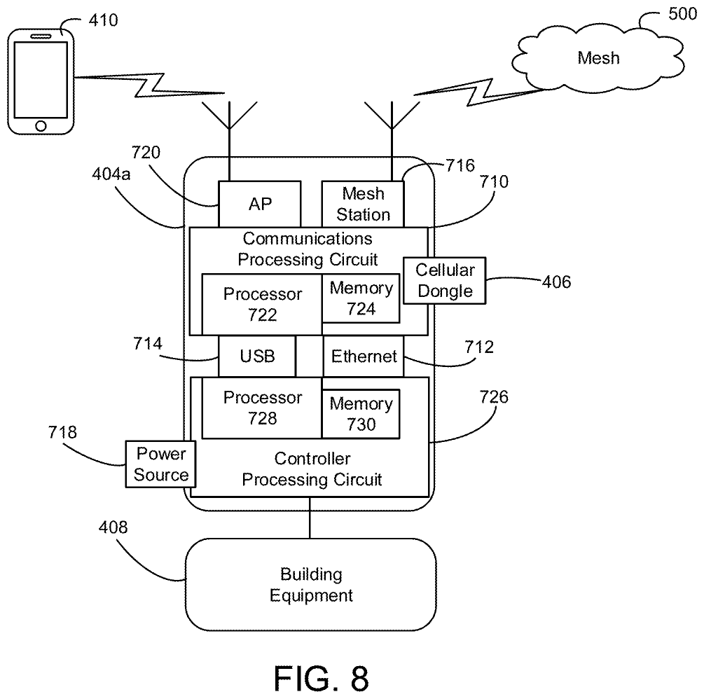

Referring to FIGS. 8-12 and 15-17, one of network devices 404a-k, network device 404a, is shown according to various embodiments. In some embodiments, any of network devices 404a-k are configured to support wireless and dynamic update and/or redefine of any parameters, including but not limited to a Dynamic Host Configuration Protocol (DHCP), a Domain Name System (DNS), etc., to transition the network which network devices 404a-k form (e.g., network 500) from a temporary mesh network to a permanent mesh network. In some embodiments, any of network devices 404a-k can be transitioned from a MESH mode to a STATION mode. In some embodiments, network devices 404a-k are configured to update to transition from the temporary mesh network to the permanent mesh network through a software-only change. In some embodiments, network devices 404a-k are configured to update any of the parameters (e.g., to transition from the temporary mesh network to the permanent mesh network) wirelessly, without requiring any of the network devices 404a-k to be wiredly connected. In some embodiments, network devices 404a-k are configured to transition from the temporary mesh network to the permanent mesh network without requiring additional hardware. In some embodiments, network devices 404a-k follow IT standards such that they are compatible with a standard permanent IT network. In some embodiments, network devices 404a-k are configured to identify one of network devices 404a-k as a bridge or router to a permanent IT infrastructure. In some embodiments, network devices 404a-k are configured to transition from the temporary network to the permanent network without any additional hardware changes, device removal, or device additions. In some embodiments, any of network devices 404a-k use any of the functionality found in U.S. patent application Ser. No. 16/543,452, filed Aug. 16, 2019, which is incorporated herein by reference in its entirety.

In some embodiments, any of network devices 404a-k act as a converter to allow a device capable of Ethernet communications to be connected to a wireless mesh network. In some embodiments, the network device which the device is connected to handles all the wireless and meshing capabilities so that the connected device does not need to, but is still a member of the Ethernet/IP network.

Referring now to FIG. 8, one of network devices 404a-k, network device 404a, as described with reference to FIGS. 4-6, is shown in greater detail, according to an exemplary embodiment. Network device 404a is shown to include communications processing circuit 710, controller processing circuit 726, cellular dongle 406, Ethernet port 712, USB interface 732, USB port 714, access point 720, mesh station 716, and power source 718. It should be understood that while network devices 404 are described herein as using a cellular dongle 406, an access point 720, a mesh station 716, a wireless radio, a wireless transceiver, etc., any of network devices 404 may also communicate with each other or with any other external devices, systems, servers, etc., using a communications interface that may include a wireless radio, a wireless transceiver, an Ethernet interface, a USB interface, a Bluetooth radio or chip, a LoRa chip, a Zigbee chip, etc., or any combination thereof.

Power source 718 may be any kind of permanent and/or temporary power source. In some embodiments, power source 718 is a battery while in various embodiments, power source 718 is a connection port for permanent power source (e.g., AC power and/or DC power) such as a wired 24 VAC, 120 VAC, and/or 240 VAC connection. In various embodiments, power source 718 may include both a port for permanent power and/or a power circuit and a battery. In some embodiments, network device 404a connects to a piece of building equipment 408 via power source 718 and receives power from the piece of building equipment 408. In this regard, power source 718 can be configured to power network device 404a when there is no permanent power source. Further, power source 718 can be configured to power network device 404a via the permanent power source if the permanent power source is connected to power source 718. For example, a power circuit (e.g., power filters, rectifiers, power regulators) can receive power via a permanent power source of the building 10 and power the network device 404a to form a permanent network in the building 10. In various embodiments, when a permanent power source is plugged into power source 718, power source 718 is configured to charge a battery of power source 718. Since the power source 718 can be either or both of a battery or a permanent power connection, the network device 404a can be used in a temporary network (powered via the battery) and also left in a permanent network (powered via the permanent power connection). In some embodiments, power source 718 is a connection port for permanent AC power source. Power source 718 may be configured to convert the permanent AC power to DC power to power network device 404a, according to some embodiments.

Power source 718 can be a battery and can be configured to store and release a charge. In some embodiments, power source 718 is a rechargeable battery, a one-time use battery, a capacitor, and/or any other energy storing device. In some embodiments, power source 718 stores charge which can be used to power network device 404a. Power source 718 may be any type or combination of batteries, capacitors (e.g., super capacitors), and/or any other energy storage device. In some embodiments, the battery is a nickel cadmium (Ni—Cd) battery and/or a nickel-metal hydride (Ni-MH) battery. In various embodiments, the battery is a lithium ion battery and/or a lithium polymer battery.

USB port 714 may be a port for connecting a USB device to network device 404a. In some embodiments, USB port 714 is configured to allow cellular dongle 406 to connect to network device 404a and provide network device 404a access to the Internet and/or another network (e.g., an upstream network). Cellular dongle 406 may be any cellular dongle that provides network device 404a with an Internet connection or other upstream network connection, that is, a connection to a cellular tower (e.g., cellular tower 402). Cellular dongle 406 is described with further reference to FIGS. 4-6. An “upstream network connection” or an “upstream network” may be another network that network device 404a can act as a gateway to. In various embodiments, an upstream network is a WAN such as the Internet. USB port may also be used to connect network device 404a to and communicate with building equipment 408 according to some embodiments. If USB port 714 is used to connect network device 404a to and communicate with building equipment 408, USB port 714 may be connected to controller processing circuit 726 according to some embodiments. USB port 714 may receive information regarding the operation of the building equipment 408 (e.g., power consumption, setpoints, efficiency, etc.), and it may also transmit information to the building equipment 408 to adjust the operation of the building equipment 408 (e.g., power consumption, setpoints, etc.). USB port 714 may be configured to connect to only one building equipment 408, or there may be multiple USB ports 714 which are configured to connect to more than one building equipment 408. Building equipment 408 may include thermostats, chillers, air-handling units, fire alarms, etc., or any other building equipment.

Ethernet port 712 can be an Ethernet port for connecting to the Internet or another upstream network. In some embodiments, Ethernet port 712 is a port for connecting network device 404a to a router, a network switch, and/or a modem. Ethernet port 712 may be labeled to indicate that network Ethernet port 712 is meant to be used in connecting network device 404a to an Internet connection. Ethernet port 712 may also be an Ethernet port for connecting building equipment 408 (e.g., a chiller, a smoke detector, a thermostat, etc.) to network device 404a according to some embodiments. Ethernet port 712 may be used to connect to a backhaul Ethernet 700. For example, if the mesh 500 is incorporated into the permanent network, or the mesh 500 becomes or is the permanent network, Ethernet port 712 may be used to hardwire the network devices to the backhaul Ethernet so that they can communicate with each other or so that they can be monitored and controlled by the permanent network. In some embodiments, there are two Ethernet ports 712, one for sending/receiving data to the building equipment 408, and one for connecting the network device 404a to the internet and/or backhaul Ethernet 700. In some embodiments, only network device 404a connects to the backhaul Ethernet 700 via Ethernet port 712, and the rest of the network devices 404 communicate wirelessly with network device 404a.

Mesh station 716 may be any kind of wireless transmitter and/or receiver. In some embodiments, mesh station 716 is a plurality of similar and/or dissimilar wireless radios. Mesh station 716 can be configured to communicate with other network devices and/or provide a wireless access point for user devices and/or building equipment. In some embodiments, mesh station 716 is a radio configured to communicate via Wi-Fi, ZigBee (e.g., ZigBee IP, ZigBee Pro Green Power), Bluetooth, LoRa, a local area network (LAN), a metropolitan area network (MAN), a wide area network (WAN) (e.g., the Internet), ad hoc wireless communication (e.g., MANET, VANET, SPANET, iMANET), and/or any other type of wireless communication. In some embodiments, mesh station 716 is configured to only connect to the mesh network 500. In some embodiments, mesh station 716 is configured to connect to the meth network 500 as well as connecting to a user device 410.

Network device 404a is shown to include communications processing circuit 710 according to some embodiments. Communications processing circuit 710 includes processor 722 and memory 724 according to some embodiments. Communications processing circuit 710 can be configured to perform some and/or all of the functionality of network device 404a. In some embodiments, communications processing circuit 710 is configured to perform some or all of the functionality necessary for connecting to the mesh 500 and for transmitting information to and from the mesh 500. In some embodiments, communications processing circuit 710 is configured to perform the functionality necessary to operate access point 720, mesh station 716, and to transfer information between communications processing circuit 710 and controller processing circuit 726. Processor 722 can be a general purpose or specific purpose processor, an application specific integrated circuit (ASIC), one or more field programmable gate arrays (FPGAs), a group of processing components, or other suitable processing components. Processor 722 may be configured to execute computer code and/or instructions stored in memory 724 or received from other computer readable media (e.g., CDROM, network storage, a remote server, etc.). In some embodiments, memory 724 stores a Linux operating system, the Linux operating system can facilitate some and/or all of the functionality of the components of memory 724. In some embodiments, network device 404a includes communications processing circuit 710 and controller processing circuit 726. Communications processing circuit 710 and controller processing circuit 726 may be configured to operate independently from each other according to some embodiments. In some embodiments, communications processing circuit 710 and controller processing circuit 726 may be segregated in different housings.

Memory 724 can include one or more devices (e.g., memory units, memory devices, storage devices, etc.) for storing data and/or computer code for completing and/or facilitating the various processes described in the present disclosure. In some embodiments, memory 724 stores data and/or computer code for completing and/or facilitating the various processes relevant to the operation of communications processing circuit 710, mesh station 716, and access point 720. Memory 724 can include random access memory (RAM), read-only memory (ROM), hard drive storage, temporary storage, non-volatile memory, flash memory, optical memory, or any other suitable memory for storing software objects and/or computer instructions. Memory 724 can include database components, object code components, script components, or any other type of information structure for supporting the various activities and information structures for the server device. Memory 724 can be communicably connected to processor 722 via communications processing circuit 710 and can include computer code for executing (e.g., by processor 722) one or more processes.

Access point 720 can be configured to act as a wireless access point for mobile devices such as user device 410. Access point 720 can be configured to connect user device 410 to the Internet. An access point for user device 410 can allow a technician to look up various equipment specifications, generate reports for equipment testing, etc. In this regard, user device 410 can communicate with the mesh network 500 via mesh station 716 and can communicate over the Internet via cellular dongle 406 and/or Ethernet port 712. User device 410 may communicate to access point 720 and access point 720 can be configured to route data to/from user device 410 to another network device that does have connection to the Internet (e.g., network device 404b). This routing may be facilitated by mesh station 716. In some embodiments, access point 720 is configured to act as a wireless access point for mobile devices such as user device 410 to receive information regarding the building equipment 408.

Mesh station 716 can be configured to route data over a mesh network (e.g., mesh network 500). Mesh station 716 can be configured to determine network devices (e.g., network device 404b) that are connected to network device 404a and/or network devices that are in a mesh network with network device 404a. Mesh station 716 can be configured to form a mesh network with other network devices, allowing network device 404a to transmit data from network device 404a to other network devices via the mesh network. Mesh station 716 may use standards such as IEEE 802.11s or any variation of IEEE 802.11s to implement a mesh network between network devices. Mesh station 716 may utilize stored information (e.g., stored and/or shared information) regarding the links between various network devices to determine the most efficient path in the mesh network to forward data.

Mesh station 716 can be configured to establish links with other network devices for the purpose of being able to forward data packets on each other's behalf. This concept of forwarding packets is what makes it possible for data at one network device to be passed from network device to network device to reach its destination on another network device, on building equipment 408, or the Internet, even when the source and destination devices are not in direct range of each other. When forwarding information, mesh station 716 can be configured to use the stored links between network device to determine a quickest path for sending data from one network device to another network device.

Network device 404a is also shown to include controller processing circuit 726, according to some embodiments. Controller processing circuit 726 may include processor 728 and memory 730 according to some embodiments. In some embodiments, controller processing circuit 726 can be configured to perform some and/or all of the functionality of network device 404a. In some embodiments, controller processing circuit 726 is configured to perform some or all of the functionality necessary for controlling building equipment 408 and for transferring information between communications processing circuit 710 and controller processing circuit 726. Processor 728 can be a general purpose or specific purpose processor, an application specific integrated circuit (ASIC), one or more field programmable gate arrays (FPGAs), a group of processing components, or other suitable processing components. Processor 728 may be configured to execute computer code and/or instructions stored in memory 730 or received from other computer readable media (e.g., CDROM, network storage, a remote server, etc.). In some embodiments, memory 730 stores a Linux operating system, the Linux operating system can facilitate some and/or all of the functionality of the components of memory 730.

Memory 730 can include one or more devices (e.g., memory units, memory devices, storage devices, etc.) for storing data and/or computer code for completing and/or facilitating the various processes relevant to the operation of controller processing circuit 726, and for controlling the operation of building equipment 408 according to some embodiments. In some embodiments, memory 730 stores data and/or computer code for methods of receiving information from building equipment 408 and data and/or computer code for transmitting this information from controller processing circuit 726 to communications processing circuit 710. Memory 730 can include random access memory (RAM), read-only memory (ROM), hard drive storage, temporary storage, non-volatile memory, flash memory, optical memory, or any other suitable memory for storing software objects and/or computer instructions. Memory 730 can include database components, object code components, script components, or any other type of information structure for supporting the various activities and information structures related to controller processing circuit 726. Memory 730 can be communicably connected to processor 728 via controller processing circuit 726 and can include computer code for executing (e.g., by processor 728) one or more processes.

Controller processing circuit 726 is also shown to connect to power source 718 according to some embodiments. In some embodiments, controller processing circuit 726 is supplied with DC power by power source 718. Controller processing circuit 726 may transmit power to communications processing circuit 710 through USB interface 732 according to some embodiments. In some embodiments, USB interface 732 is configured to transfer information and/or data between communications processing circuit 710 and controller processing circuit 726, as well as transferring power from controller processing circuit 726 to communications processing circuit 710.

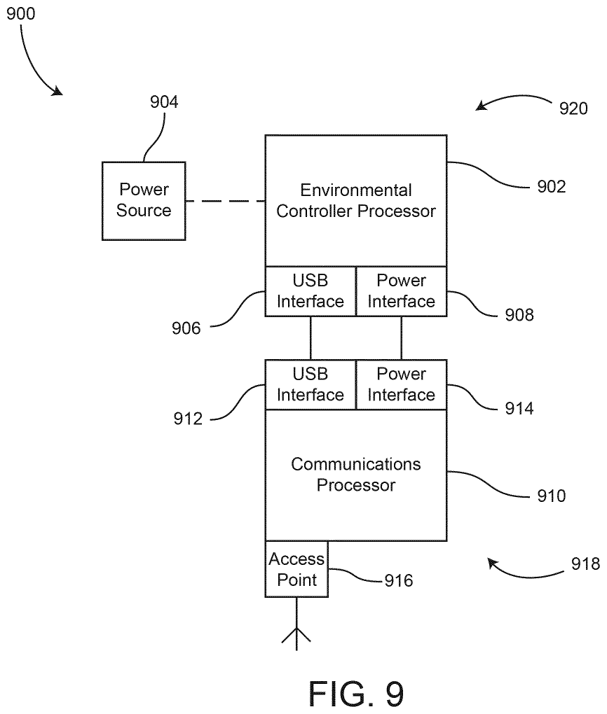

Referring now to FIGS. 9-12, the network devices 404a-404k may also be any one of several devices, as described below. In some embodiments, network devices 404a-404k may be server devices, environmental controller devices, sensors, access points, power adapters, or other devices which perform different functions yet are communicably linked. Each of these devices may include sub-components which perform different functions, according to some embodiments. Various configurations and numeration of the different devices are possible according to some embodiments. In some embodiments, for example, all of the network devices 404a-k may be environmental controller devices configured to transmit information between each other via access point devices. In some embodiments, one of the network devices 404a-k may be a server device, and the other network devices 404a-k may be a combination of access points, environmental controllers, etc.

Referring now to FIG. 9, one of the network devices 404a-k, is shown as a controller/processor device 900, according to some embodiments. In some embodiments, controller/processor device 900 may have segregated processors which may operate independently of one another. Controller/processor device 900 may include environmental controller 920 and access device 918 according to some embodiments. Environmental controller 920 may include environmental controller processor 902, USB interface 906, and power interface 908 according to some embodiments. In some embodiments, access device 918 may include communications processor 910, USB interface 912, power interface 914, and access point 916.

Environmental controller processor 902 may be configured to process information regarding building equipment 408 and may be configured to operate building equipment 408. In some embodiments, environmental controller processor 902 may control or adjust the operation of thermostats, chillers, air-handling units, fire alarms, etc., or any other building equipment 408. In some embodiments, environmental controller processor 902 is configured to be supplied with power from a power source 904. Power source 904 may be a battery, a wall outlet, or any other electrical power source according to some embodiments. In some embodiments, power source 904 may be a re-chargeable battery, or a one-time use battery. In some embodiments, environmental controller processor 902 is directly wired to power source 904. In some embodiments, communications processor 910 receives power from environmental controller processor 902 through power interface 908 and power interface 914 or USB interface 906 and USB interface 912.

Environmental controller processor 902 and communications processor 910 may both receive power from power source 904 and may also each include a backup power source (e.g., a battery), integrated into the environmental controller processor 902 or communications processor 910 according to some embodiments. In some embodiments, environmental controller processor 902 and communications processor 910 may be configured to draw power from each of their backup power sources if the power source 904 fails. In some embodiments, only environmental controller processor 902 has backup power source, and communications processor 910 may receive power from the backup power source of environmental controller processor 902 through power interfaces 908 and 914 or USB interfaces 906 and 912, if power source 904 fails. In this way, if power source 904 fails, the controller/processor device 900 may continue to operate and control the equipment so that the mesh and the equipment do not cease functioning if power source 904 fails.

According to some embodiments, environmental controller processor 902 is configured to communicate with communications processor 910 through a USB interface 906. USB interface 906 may be configured to communicate with USB interface 912 of communications processor 910. In some embodiments, USB interface 906 and USB interface 912 are any other serial communications interface, such as SPI (serial peripheral interface), I2C (inter-integrated circuit), FireWire, Ethernet, etc. Communications processor 910 may be configured to receive and send information in the mesh network (e.g., mesh network 500) via access point 916 in some embodiments.

In some embodiments, access point 916 may be a radio configured to communicate with the mesh via Wi-Fi, ZigBee (e.g., ZigBee IP, ZigBee Pro Green Power), Bluetooth, LoRa, a local area network (LAN), a metropolitan area network (MAN), a wide area network (WAN) (e.g., the Internet), ad hoc wireless communication (e.g., MANET, VANET, SPANET, iMANET), and/or any other type of wireless communication. Access point 916 may send information regarding the status and operation of the communications processor 910, the environmental controller processor 902, or the building equipment 408 which the environmental controller processor 902 controls. In some embodiments, access point 916 may receive information from the other network devices 402, regarding the operation and/or status of the communications processor 910 of the other network devices 402, the environmental controller processor 902 of the other network devices 402, and the building equipment 408 of the other network devices 402. In some embodiments, the other network devices 404 are the same as controller/processor device 900 shown in FIG. 9.

Communications processor 910 may transmit the information received from the access point 916 to the environmental controller processor 902 through USB interface 912 according to some embodiments. Environmental controller processor 902 may receive the information received from the access point 916 of the environmental controller processor 902 through USB interface 906. In some embodiments, environmental controller processor 902 may be configured to process the information received through USB interface 906 and may control and/or adjust the operation of building equipment 408 based on the information received through USB interface 906. In some embodiments, environmental controller processor 902 may transmit information to communications processor 910 through USB interfaces 906 and 912. Communications processor 910 may then transmit the information to the mesh according to some embodiments. In some embodiments, the information is information regarding the operation or status of the building equipment 408 controlled by environmental controller processor 902. For example, communications processor 910 may receive information from the mesh through access point 916 and transmit this information to environmental controller processor 902 through USB interface 912 and USB interface 906, according to some embodiments.

In some embodiments, environmental controller processor 902 may process the information regarding the operation of the other building equipment 408, and determine an adjustment of the operation of the building equipment 408 which environmental controller processor 902 controls. In some embodiments, environmental controller processor 902 may also receive commands from other network devices 404 (e.g., from a server device), and control the building equipment 408 based on the commands received. For example, if environmental controller processor 902 controls the operation of a thermostat, environmental controller processor 902 may determine that a setpoint of the thermostat should be increased, according to some embodiments. In some embodiments, environmental controller processor 902 may adjust the setpoint of the thermostat, and send information regarding the adjusted thermostat setpoint to the communications processor 910 through the USB interfaces 906 and 912. Communications processor 910 may then transmit the information regarding the adjusted thermostat setpoint to the mesh through access point 916.

In some embodiments, communications processor 910 may receive a command to adjust the operation of the building equipment 408 through access point 916. The command to adjust the operation of the building equipment 408 may be sent from a server device and may be communicated through the mesh to communications processor 910 according to some embodiments. In some embodiments, communications processor 910 may communicate the command to environmental controller processor 902 through USB interface 906 and USB interface 912. Environmental controller processor 902 may then adjust the operation of the building equipment 408 based on the command received from the server. When the operation of the building equipment 408 has been adjusted, environmental controller processor 902 may be configured to transmit information to communications processor 910 that the operation of the building equipment 408 has been adjusted, and communications processor 910 may transmit this information back to the server through access point 916 and the mesh.

In some embodiments, communications processor 910 is powered through power interface 914. Power interface 914 may be connected to power interface 908 and may receive power from power interface 908. In some embodiments, power interface 908 receives power from power source 904 and is configured to supply communications processor 910 with power through power interface 914. In some embodiments, communications processor 910 may receive power through power interface 914 from a power source. The power source may be a battery or an outlet. In some embodiments, the power source of communications processor 910 is separate from power source 904 of environmental controller processor 902. For example, both communications processor 910 and environmental controller processor 902 may receive power through a corded connection to an outlet.

In some embodiments, communications processor 910 and environmental controller processor 902 each cordedly connect to separate outlets. In some embodiments, communications processor 910 and environmental controller processor 902 each include a battery as their power source. In some embodiments, the batteries of communications processor 910 and environmental controller processor 902 may be backup batteries, with the communications processor 910 and environmental controller processor 902 both receiving power input from an outlet, and relying on power from the batteries if the power input from the outlet fails. In some embodiments, communications processor 910 receives power from environmental controller processor 902 through USB interfaces 906 and 912 or power interfaces 908 and 914. In some embodiments, communications processor 910 may only receive power when environmental controller processor 902 receives power from power source 904. In this way, communications processor 910 may only receive power if environmental controller processor 902 receives power. In some embodiments, communications processor 910 relies on environmental controller processor 902 for power but may operate independently from environmental controller processor 902.

In some embodiments, communications processor 910 and environmental controller processor 902 may operate independently from each other. For example, communications processor 910 may receive power from the power source without being connected to environmental controller processor 902, according to some embodiments. In some embodiments, communications processor 910 receives power from power source 904 through environmental controller processor 902, but still operates independently from environmental controller processor 902 (e.g., communications processor 910 may receive and send information to and from the mesh without environmental controller processor 902 controlling building equipment 408). Communications processor 910 may then be configured to communicate with the mesh through access point 916 according to some embodiments. When the communications processor 910 has been configured to communicate with the mesh, the environmental controller processor 902 may then be connected to communications processor 910 so that the building equipment 408 can be controlled according to some embodiments.

In some embodiments, communications processor 910 may require connection to environmental controller processor 902 to be powered, but may operate independently of environmental controller processor 902. For example, communications processor 910 may receive power from the environmental controller processor (through either USB interface 912/906 or power interface 908/914) and may be configured to communicate with the mesh without the environmental controller processor 902 being configured to operate or adjust the operation of building equipment 408. In some embodiments, power may be transferred from the environmental controller processor 902 to the communications processor 910 through either the USB interfaces 906 and 912 or through the power interfaces 908 and 914. In some embodiments, power interfaces 908 and 914 may be a second USB interface and may transmit power from the environmental controller processor 902 to the communications processor 910. In some embodiments, USB interfaces 906 and 912 may transmit information between the environmental controller processor 902 and the communications processor 910 as well as transmitting power between the environmental controller processor 902 and the communications processor 910.

In some embodiments, environmental controller 920 and access device 918 may be contained in separate housings. In some embodiments, environmental controller 920 and access device 918 are contained in separate housings but are connected to each other via wires connected to USB interfaces 906 and 912 and power interfaces 908 and 914. The wired connections between USB interfaces 906 and 912 and power interfaces 908 and 914 may be a selectively removable wired connection according to some embodiments. In some embodiments, environmental controller 920 and access device 918 are contained in the same housing, yet still remain segregated in their operation and function.

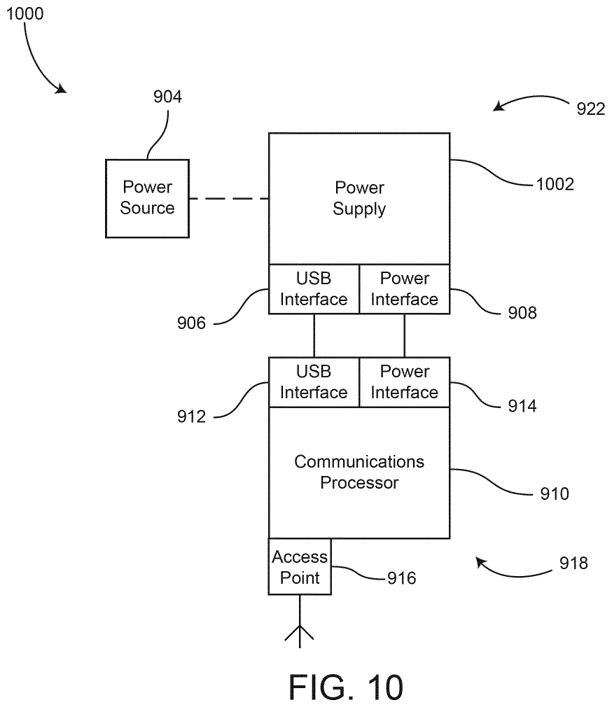

In other embodiments, access device 918 may remain the same, while environmental controller 920 may be replaced by other devices, as described in FIGS. 10-12 below. Environmental controller 920 may be replaced by a power adapter, a server, etc., yet the access device 918 may remain structurally the same, and may connect the power adapter, server, or environmental controller 920 to the mesh according to some embodiments.

Referring now to FIG. 10, one of the network devices 404a-404k is shown as a power adapter/mesh access point device 1000 according to some embodiments. Power adapter/mesh access point device 1000 may act as a device to help widen the area of the mesh without necessarily operating building equipment 408 according to some embodiments (see network device 404g of FIG. 6). In some embodiments, power adapter/mesh access point device 1000 includes power adapter 922 and access device 918.

Power adapter 922 includes power supply 1002 which draws power from power source 904 according to some embodiments. Power adapter 922 may also include USB interface 906, and power interface 908. In some embodiments, power adapter 922 merely supplies access device 918 with power that it receives from power source 904. Power adapter 922 may not necessarily be configured to control the operation of any building equipment 408, according to some embodiments.

In some embodiments, access device 918 includes communications processor 910, access point 916, USB interface 912, and power interface 914. Communications processor 910 may be configured to receive and send information to and from the mesh via access point 916 according to some embodiments. In some embodiments, access device 918 may receive and transmit information from one network device 404 to another network device 404 via access point 916.

Power adapter/mesh access point device 1000 may be placed in the building at a location where the mesh signal strength is low according to some embodiments. In some embodiments, power adapter/mesh access point device 1000 may be placed in “dead” zones of the building where the mesh does not reach or where there is no signal strength. In some embodiments, power adapter/mesh access point device 1000 may be used to increase the overall size of the mesh to improve communication between network devices 404. For example, if there are two network devices 404 positioned in either end of the building, and both the network devices 404 are configured to control the operation of building equipment 408 (i.e., the network devices may each be controller/processor device 900), it may be necessary to provide wireless communication between the two network devices 404 according to some embodiments.

In some embodiments, wireless communication between the two network devices 404 may be accomplished by placing other network devices 404 in between the two network devices 404. However, if the network devices 404 in between the two network devices 404 do not need to control the operation of building equipment 408, network devices 404 positioned in between the two network devices 404 may be power adapter/mesh access point devices 1000 according to some embodiments. In this way, power adapter/mesh access point devices 1000 may be used to increase the mesh so that network devices 404 may communicate with each other, without controlling building equipment 408 itself according to some embodiments.

In some embodiments, controller/processor devices 900 may be used to initially create the mesh and may be configured to communicate wirelessly with each other, without being configured to control building equipment 408. In some embodiments, power adapter/mesh access point devices 1000 may be transitioned into controller/processor device 900. If power adapter 922 and access device 918 are connected via a removable wired connection, power adapter 922 may be disconnected from access device 918 and replaced with environmental controller 920 according to some embodiments. In this way, if power adapter/mesh access point device 1000 is installed at a location in the building where there is no building equipment 408, but building equipment 408 is later installed at this location, power adapter/mesh access point device 1000 may be transitioned into controller/processor device 900 according to some embodiments.

In some embodiments, power adapter/mesh access point device 1000 may be configured to communicate with the mesh before being transitioned into controller/processor device 900. Advantageously, this allows flexibility and allows the mesh to easily adjust to the addition of building equipment 408. Additionally, the power adapter/mesh access point device 1000 may be fully configured to communicate with the mesh before the installation of building equipment 408 and the transition of power adapter/mesh access point device 1000 into controller/processor device 900. For example, network devices 404 may be installed throughout a building as power adapter/mesh access point devices 1000 before building equipment 408 has been installed. Network devices 404 may be configured to communicate to form a mesh network (e.g., mesh network 500 or mesh network 400). The building equipment 408 may then be installed at locations near network devices 404 according to some embodiments. The network devices 404 near the building equipment 408 may then be transitioned into controller/processor devices 900 by disconnecting the power adapter 922 and connecting environmental controller 920 in place of controller/processor device 900. Environmental controller 920 may then be configured to operate and adjust the operation of the building equipment 408.

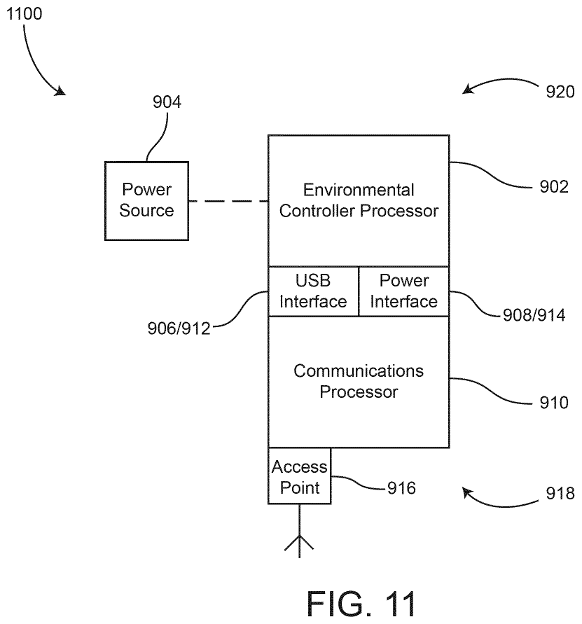

Referring now to FIG. 11, a controller/processor device 1100 is shown, according to some embodiments. In some embodiments, controller/processor device 1100 is controller/processor device 900 as shown in FIG. 9. Any of the network devices 404a-k may be controller/processor device 1100 as shown in FIG. 11, according to some embodiments. As shown in FIG. 11, environmental controller processor 902 and communications processor 910 are co-located, such that USB interface 906/912 and power interface 908/914 are integrally connected according to some embodiments. In some embodiments, controller/processor device 1100 is contained in a single housing and is configured to draw power from power source 904.

While environmental controller processor 902 and communications processor 910 may be contained in a single housing and may be co-located, environmental controller processor 902 and communications processor 910 may still operate independently from each other in their function. For example, environmental controller processor 902 may need to be calibrated and configured before it can control and adjust the operation of building equipment 408 according to some embodiments. In some embodiments, communications processor 910 may also need to be calibrated and configured before it can communicate with the mesh. In some embodiments, the function of communications processor 910 does not rely on the environmental controller processor 902 being calibrated and configured to control building equipment 408. Communications processor 910 may be calibrated and configured to communicate with the mesh and may send and receive information with the mesh without environmental controller processor 902 being configured or calibrated to adjust the operation of building equipment 408 according to some embodiments.

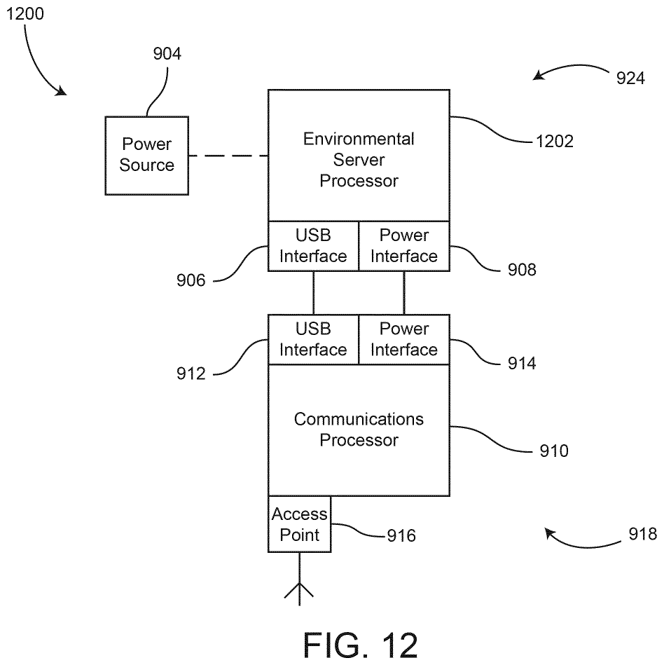

Referring now to FIG. 12, a server device 1200 is shown, according to some embodiments. In some embodiments, any of the network devices 404a-k may be server device 1200. In some embodiments, only one of the network devices 404a-k is server device 1200 (e.g., only network device 404a is server device 1200). Server device 1200 is shown to include server 924, and access device 918. In some embodiments, server 924 includes environmental server processor 1202, In some embodiments, environmental server 924 includes environmental server processor 1202, USB interface 906, and power interface 908. Server device 1200 may collect and store information regarding each of the network devices 404 according to some embodiments. For example, in some embodiments, server device 1200 may collect information through the mesh regarding the status and operation of the building equipment 408 which network devices 404 may be configured to control. Server device 1200 may store this information in a memory of environmental server processor 1202 according to some embodiments.

The memory of environmental server processor 1202 may include one or more devices (e.g., memory units, memory devices, storage devices, etc.) for storing data and/or computer code for completing and/or facilitating the various processes described in the present disclosure. The memory may include random access memory (RAM), read-only memory (ROM), hard drive storage, temporary storage, non-volatile memory, flash memory, optical memory, or any other suitable memory for storing software objects and/or computer instructions. The memory may include database components, object code components, script components, or any other type of information structure for supporting the various activities and information structures described in the present disclosure. The memory may be communicably connected to environmental server processor 1202 and can include computer code for executing (e.g., by environmental server processor 1202) one or more processes described herein.

In some embodiments, the other network devices 404 are clients of server device 1200. In some embodiments, network devices 404 may transmit information regarding their status and the operational state of building equipment 408 to the server device continuously. For example, server device 1200 may receive a continuous stream of information from the mesh regarding the live status of network devices 404 and/or the operational status of building equipment 408. In some embodiments, server device 1200 may broadcast this information to the mesh through access device 918. In some embodiments, server device 1200 may process the information received from the mesh and determine adjustments to the building equipment 408 to be executed by the network devices 404. In some embodiments, network devices 404 may receive a command regarding the adjustments to make to building equipment 408 from the server device 1200 through the mesh. In some embodiments, network devices 404 may communicate with the server device 1200 regarding adjustments to make to the operation of the building equipment 408 and may receive information from neighboring network devices 404.

Server device 1200 may be configured to operate in a request-serve basis, or a continuous basis. For example, one of the network devices 404 may send a request to the server device 1200 through the mesh (e.g., a request regarding the operational status of other building equipment 408, or a request of what adjustments to make to the building equipment 408 the network device 404 operates). The server device 1200 may then process the request and transmit the response (e.g., information or a command of how to operate the building equipment 408) to the network device 404 through the mesh. In some embodiments, the network device 404 may receive information from the other network devices 404 and may send a request to the server device 1200 through the mesh of how to operate the building equipment 408 based on the information received from the other network devices 404.

In some embodiments, server device 1200 may operate on a continuous basis. For example, there may be a constant exchange of information in the mesh and between the network devices 404 and the server device 1200. In some embodiments, the server device 1200 continuously receives and transmits information between the server device 1200 and the mesh. In some embodiments, the network devices 404 continuously transfer information between each other and to and from the server device 1200. In some embodiments, there is a constant exchange of information and/or commands between the network devices 404 and the server device 1200 according to some embodiments. In this way, the server device 1200 can constantly monitor and collect information regarding the mesh (e.g., building equipment 408 status, building equipment 408 performance, network device status, etc.) according to some embodiments.

In some embodiments, the server device 1200 may continuously provide information and/or commands into the mesh and the network devices 404 regarding the operation of the building equipment 408. In some embodiments, the information transferred between the server device 1200 and the mesh and network devices 404 may be stored in memory of the environmental server processor 1202 of server device 1200. In some embodiments, server device 1200 may connect to the Internet via a cellular dongle, and may transmit information to a remote database. In some embodiments, the information transmitted to the remote database may be the information received and transmitted from the mesh and/or network devices 404 to the server device 1200 and may be stored in the remote database.

In some embodiments, server device 1200 may be accessed via a personal computer device, such as a tablet, a smart phone, a laptop, etc., or any other device that can connect to the Internet. The personal computer device may connect directly to the access point 916 of the server device 1200 and may access the information stored on the memory of server device 1200. In some embodiments, when the personal computer device connects to server device 1200, the personal computer device may access any or all of the information transferred to the server device 1200 from the mesh. In some embodiments, the personal computer device may connect to the server device 1200 by connecting to the mesh via one of the network devices 404. The personal computer device may require administrative credentials or administrative access to access the information of the server device 1200 according to some embodiments. In some embodiments, the personal computer device may connect to the Internet by connecting to the mesh or to the internet via a cellular dongle of the personal computer device, and may access the information from the server device 1200 on the remote database. In some embodiments, the remote database may be accessed by the personal computer device from a location other than inside the building and may connect to the remote database via any other Internet connection.

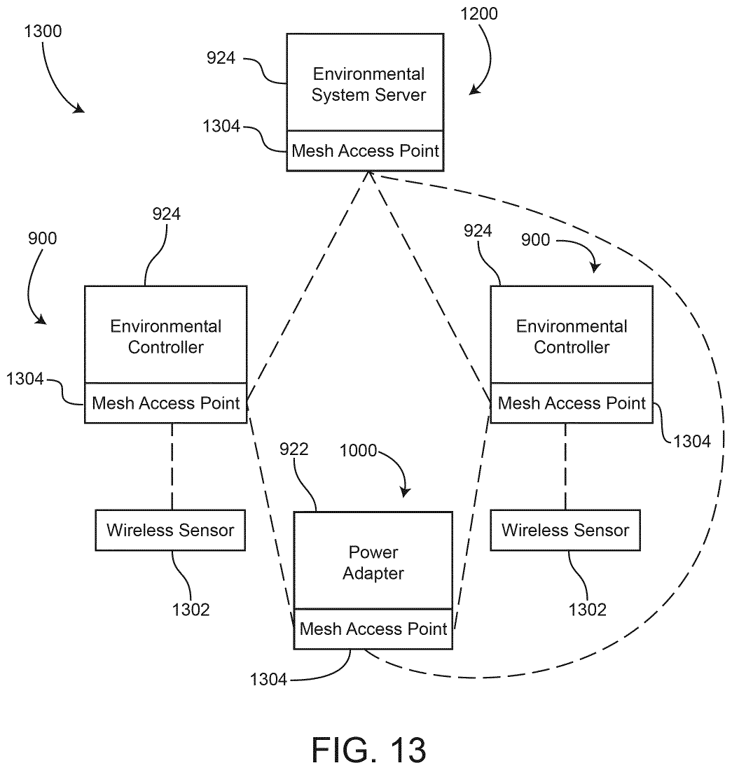

Referring now to FIG. 13, a wireless mesh system 1300 is shown, according to some embodiments. Wireless mesh system 1300 may include server device 1200, controller/processor devices 900, and power adapter/mesh access point device 1000, according to some embodiments. In some embodiments, wireless mesh system 1300 may be configured to operate independently of other network infrastructures (e.g., other building infrastructures which are not directly related to building equipment 408). In some embodiments, wireless mesh system 1300 may be a temporary wireless mesh system as described above, or it may be a permanent wireless mesh system.

Wireless mesh system 1300 is also shown to include wireless sensors 1302 according to some embodiments. In some embodiments, wireless sensors 1302 may be configured to wirelessly transmit information to mesh access points 1304. Mesh access points 1304 may be access device 918 according to some embodiments, and may include communications processor 910 and access point 916. Wireless sensors 1302 may transmit information regarding the operation or status of building equipment 408, or any other information of the building which may be used to make decisions regarding the operation of the building equipment 408 (e.g., temperature, humidity, smoke detection, occupancy, etc.) to mesh access points 1304 according to some embodiments. In some embodiments, wireless sensors 1302 may transmit information to the mesh access points 1304 using Wi-Fi, Bluetooth, ZigBee, LoRa, and/or any other wireless transmission method. In some embodiments, wireless sensors 1302 may be directly wired to mesh access points 1304 via USB, Firewire, SPI (serial peripheral interface), I2C (inter-integrated circuit), Ethernet, etc., or any other serial communication.

Wireless mesh system 1300 is also shown to include power adapter/mesh access point device 1000 according to some embodiments. FIG. 13 shows only one power adapter/mesh access point device 1000, however any number of power adapter/mesh access point devices 1000 may be used according to some embodiments. In some embodiments, power adapter/mesh access point device 1000 does not directly control the operation of building equipment 408, but may make the mesh larger and provide additional coverage to locations which may require mesh access but do not necessarily have building equipment 408 that needs to be controlled. In some embodiments, power adapter/mesh access point device 1000 may increase the size of wireless mesh system 1300 in order to provide additional area and footprint of wireless mesh system 1300.

Wireless mesh system 1300 is also shown to include controller/processor devices 900 according to some embodiments. FIG. 13 shows only two controller/processor devices 900, however any number of controller/processor devices 900 may be used according to some embodiments. In some embodiments, controller/processor device 900 may control the operation of building equipment 408. In some embodiments, controller/processor device 900 is configured to receive information from wireless sensor 1302 through mesh access point 1304. In some embodiments, mesh access point 1304 is access device 918 and communicates with the wireless mesh system 1300 or wireless sensor 1302 via access point 916. In some embodiments, controller/processor device 900 is directly wired to wireless sensor 1302.

Wireless sensor 1302 may send information to mesh access point 1304 regarding the operation or status of building equipment 408 according to some embodiments. In some embodiments, wireless sensor 1302 may be a sensor installed on building equipment 408, while in some embodiments, wireless sensor 1302 may be integrally formed with the building equipment 408. In some embodiments, wireless sensor 1302 may be part of a control system of the building equipment 408. Wireless sensor 1302 may also monitor and send information regarding the building to mesh access point 1304. For example, wireless sensor 1302 may be a thermometer, a smoke detector, a light detector, a security camera, a humidity detector, etc. In some embodiments, wireless sensor 1302 may also be a controller. In some embodiments, wireless sensor 1302 is a controller and is directly wired to controller/processor device 900. Wireless sensor 1302 may be a controller configured to adjust the operation of the building equipment 408 according to some embodiments.

In some embodiments, controller/processor device 900 includes environmental controller 920. Environmental controller 920 may be configured to control and/or adjust the operation of building equipment 408 in some embodiments. In some embodiments, environmental controller 920 may include a processing circuit configured to interpret the information received through mesh access point 1304 from the wireless mesh system 1300 and to adjust the operation of the building equipment 408 based on the information received from the wireless mesh system 1300. In some embodiments, environmental controller 920 includes environmental controller processor 902, USB interface 906, and power interface 908, as shown in FIG. 9.

Referring still to FIG. 13, wireless mesh system 1300 is shown to include server device 1200, according to some embodiments. Server device 1200 may include environmental system server 924 according to some embodiments. In some embodiments, server device 1200 may perform all of the functions as described in reference to FIG. 12. Server device 1200 may include environmental server processor 1202, USB interface 906, and power interface 908 according to some embodiments. Environmental server processor 1202 may be configured to receive information from the wireless mesh system 1300 and determine the operation of the building equipment 408 based on the information received from the wireless mesh system 1300 using various building management algorithms according to some embodiments.

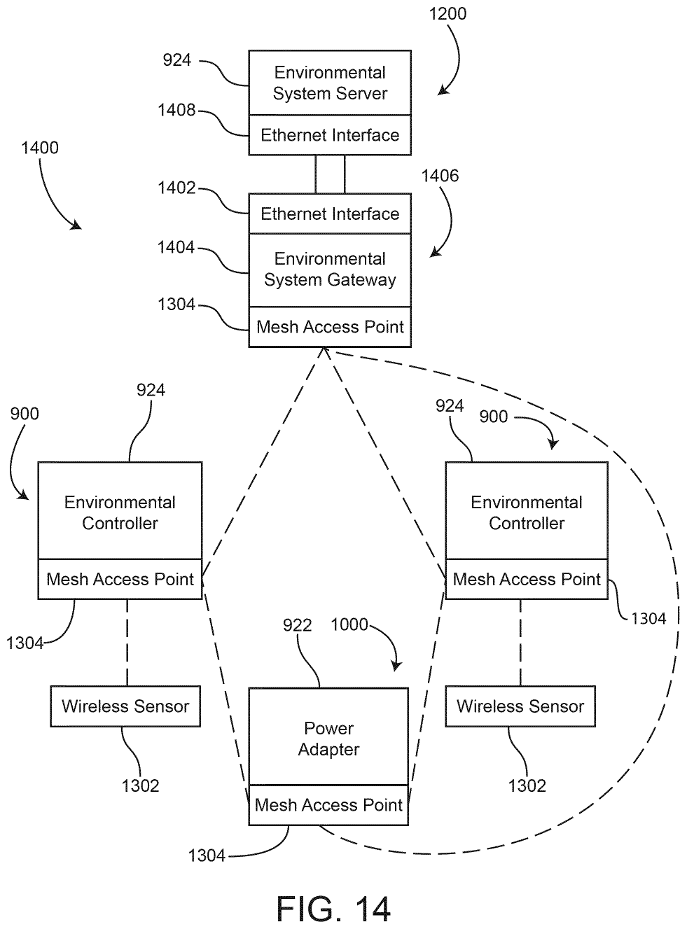

Referring now to FIG. 14, wireless mesh system 1400 is shown according to some embodiments. Wireless mesh system 1400 may include server device 1200, gateway server device 1406, controller/processor devices 900, and power adapter/mesh access point device 1000. In some embodiments, controller/processor devices 900 may be positioned a distance farther away than they are able to communicate, resulting in a communication gap. Power adapter/mesh access point device 1000 may bridge the communication gap by being placed in between the controller/processor devices 900, within range of each of controller/processor devices 900. Power adapter/mesh access point device 1000 may serve to enable the controller/processor devices 900 to communicate by providing a communication path between controller/processor devices 900.

As shown in FIG. 14, wireless mesh system 1400 is also shown to include gateway server device 1406, according to some embodiments. Gateway server device 1406 may include mesh access point 1304, environmental system gateway 1404, and Ethernet interface 1402 according to some embodiments. In some embodiments, mesh access point 1304 is access device 918. In some embodiments, mesh access point 1304 is access device 918 and includes communications processor 910 and access point 916. Gateway server device 1406 may communicate with the wireless mesh system 1400 and may receive or send information from/to wireless mesh system 1400.

In some embodiments, environmental system gateway 1404 receives information from wireless mesh system 1400 and processes or filters the information. Environmental system gateway 1404 may serve as a gateway to environmental system server 924 according to some embodiments. In some embodiments, environmental system gateway 1404 processes the information from wireless mesh system 1400 received through mesh access point 1304 and sends the information to environmental system server 924. In some embodiments, environmental system gateway 1404 may categorize the information received from wireless mesh system 1400 and send the categorized information to environmental system server 924 through Ethernet interface 1402 and Ethernet interface 1408 of server device 1200. Environmental system server 924 of server device 1200 may receive the information from environmental system gateway 1404 through Ethernet interface 1408, and may store the information in a database. In some embodiments, environmental system server 924 may store the information in memory, as described above. In some embodiments, environmental system server 924 may transmit the information to a remote database to be stored.

Environmental system server 924 may also control the operation of the building equipment 408 controlled by environmental controllers 920 according to some embodiments. In some embodiments, environmental system server 924 may send commands to the wireless mesh system 1400 which determine how the building equipment 408 should be controlled by environmental controllers 920. In order to control the operation of the building equipment 408 by sending commands to the environmental controllers 920, the server device 1200 does not necessarily have to be in direct communication with each controller/processor device 900. For example, each controller/processor device 900 may have a unique address according to some embodiments. When the controller/processor device 900 sends information to the wireless mesh system 1400 indicating the operation of the building equipment 408 which the controller/processor device 900 controls, it may include the unique address of the controller/processor device 900 so that the server device 1200 knows the controller/processor device 900 and the building equipment 408 to which the information pertains.

In some embodiments, server device 1200 may send commands to the controller/processor devices 900 through the wireless mesh network 1400. For example, in some embodiments, server device 1200 may send a command to particular controller/processor device 900 to increase a thermostat which the particular controller/processor device 900 controls by 1° F. In some embodiments, the command includes the address of the particular controller/processor device 900. If a different controller/processor device 900 with a different address receives the command from the server device 1200 (i.e., the server device 1200 may not be in direct communication with the particular controller/processor device 900 which controls the thermostat to be adjusted), the different controller/processor device 900 may send the information to the particular controller/processor device 900 with the correct address according to some embodiments. In this way, the server device 1200 does not need to be in direct communication with controller/processor devices 900 and may send an address with a command so that the command is transferred among the controller/processor devices 900 and/or power adapter/mesh access point device 1000 until it reaches the controller/processor device 900 with the correct address.

Wireless mesh system 1400 may also include wireless sensors 1302 configured to read information and send the information to mesh access points 1304 according to some embodiments. In some embodiments, wireless sensors 1302 read information regarding the status and/or operation of building equipment 408. In some embodiments, wireless sensors 1302 read information regarding the properties of the building (e.g., temperature, humidity, etc.). Wireless sensors 1302 may transmit information to the mesh access points 1304 using Wi-Fi, Bluetooth, ZigBee, LoRa, and/or any other wireless transmission method. In some embodiments, wireless sensors 1302 may be directly wired to mesh access points 1304 via USB, Firewire, SPI (serial peripheral interface), I2C (inter-integrated circuit), Ethernet, etc., or any other serial communication.

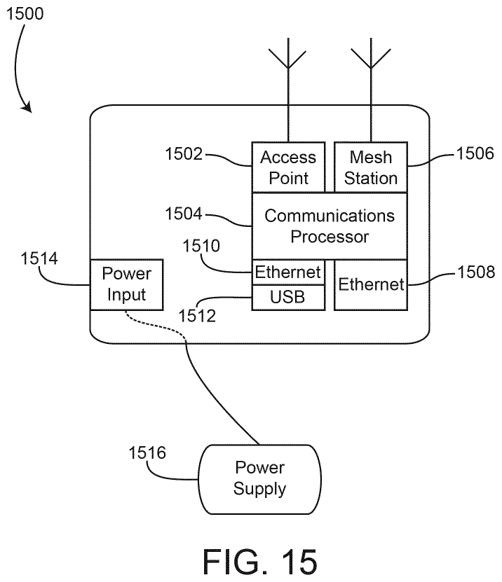

Referring now to FIG. 15, power adapter access device 1500 is shown, according to some embodiments. In some embodiments, power adapter access device 1500 is the mesh access point 1304 of power adapter/mesh access point device 1000. In some embodiments, power adapter access device 1500 is access device 918 of power adapter/mesh access point device 1000.

Power adapter access device 1500 is shown to include access point 1502, communications processor 1504, mesh station 1506, Ethernet interface 1508, Ethernet interface 1510, USB interface 1512, and power input 1514 according to some embodiments. In some embodiments, power input 1514 receives power from power supply 1516. Power supply 1516 may be an AC power source according to some embodiments. In some embodiments, power supply 1516 may be a battery, an outlet, or any other power storage device. Power input 1514 may convert the AC power from power supply 1516 to DC power and provide the DC power to the communications processor 1504 according to some embodiments. Communications processor 1504 may be a general purpose or specific purpose processor, an application specific integrated circuit (ASIC), printed circuit board (PCB), one or more field programmable gate arrays (FPGAs), a group of processing components, or other suitable processing components. In some embodiments, mesh station 1506 is configured to communicably connect power adapter access device 1500 to the mesh via Wi-Fi, ZigBee, LoRa, and/or any other wireless protocol or combination thereof. Access point 1502 may be configured to communicably connect power adapter access device 1500 to personal computer devices according to some embodiments. For example, a technician may have a smart phone and may desire to connect to the mesh to diagnose problems or to monitor device status. Access point 1502 may be configured to connect to the personal computer device via Wi-Fi, Bluetooth, ZigBee, LoRa, and/or any other wireless protocol or combination thereof.

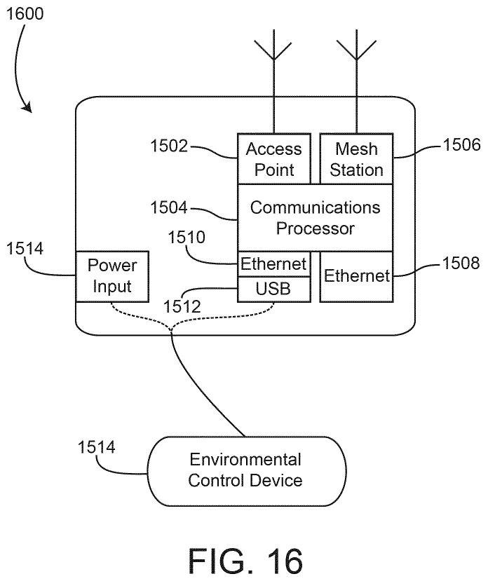

Referring now to FIG. 16, environmental controller access device 1600 is shown, according to some embodiments. In some embodiments, environmental controller access device 1600 is the mesh access point 1304 of controller/processor device 900. In some embodiments, environmental controller access device 1600 is access device 918 of controller/processor device 900.

Environmental controller access device 1600 is shown to include access point 1502, communications processor 1504, mesh station 1506, Ethernet interface 1508, Ethernet interface 1510, USB interface 1512, and power input 1514 according to some embodiments. In some embodiments, power input 1514 receives AC power from a power source and converts the AC power to DC power. The DC power may then be used to power communications processor 1504 according to some embodiments. In some embodiments, environmental control device 1520 may receive power from power input 1514. In some embodiments, the power that environmental control device 1514 receives from power input 1514 is DC power. In some embodiments, access point 1502 and mesh station 1506 may be configured to communicate with personal computer devices and the mesh, respectively, as described above.

Communications processor 1504 may be configured to perform activities required to connect access point 1502 and mesh station 1506 to perform the communication of access point 1502 and mesh station 1506, according to some embodiments. In some embodiments, communications processor 1504 receives information from the personal computer device or the mesh through access point 1502 and mesh station 1506. Communications processor 1504 may be configured to transmit the information received from the personal computer device or the mesh to environmental control device 1520 through USB interface 1512. In some embodiments, the information transmitted to environmental control device 1520 may cause environmental control device 1520 to adjust the operation of the building equipment 408 which it controls.

Environmental control device 1520 may also be configured to send information to communications processor 1504 regarding the building equipment 408 operation and/or status through USB interface 1512, according to some embodiments. In some embodiments, communications processor 1504 may transmit the information received through USB interface 1512 regarding the building equipment 408 operation and/or status to access point 1502 and/or mesh station 1506. Access point 1502 and mesh station 1506 may then transmit the information regarding the building equipment 408 operation and/or status to the personal computer device or the mesh.

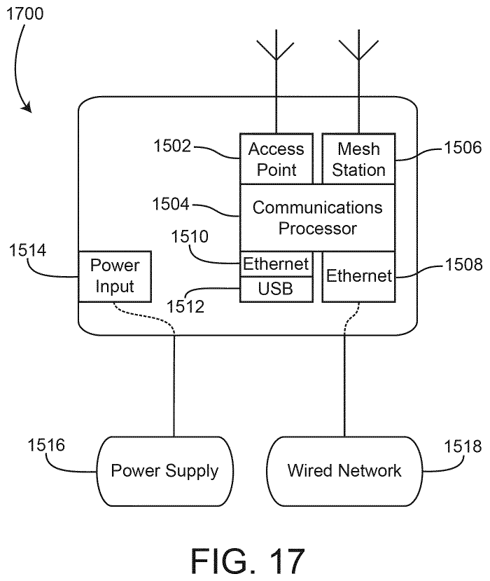

Referring now to FIG. 17, server access device 1700 is shown according to some embodiments. In some embodiments, server access device 1700 is mesh access point 1304 of gateway server device 1406. Server access device 1700 may include access point 1502, communications processor 1504, mesh station 1506, Ethernet interface 1508, Ethernet interface 1510, USB interface 1512, and power input 1514 according to some embodiments. Power input 1514 may receive AC power from power supply 1516. In some embodiments, power supply 1516 may be any power source, as discussed above. Power input 1514 may be configured to transform AC power from power supply 1516 to DC power and to provide power to communications processor 1504. Ethernet interface 1508 may be configured to transmit information between wired network 1518 and communications processor 1504 according to some embodiments.

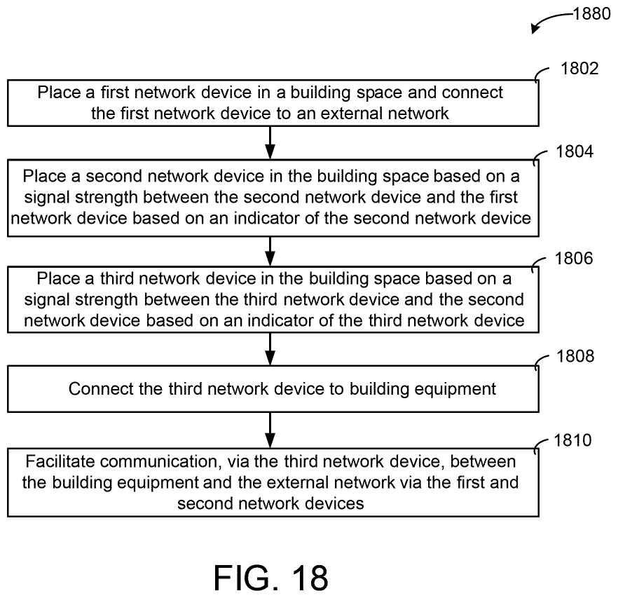

Referring now to FIG. 18, a flow diagram of process 1800 is shown for placing network devices in a building to connect building equipment 408 to an external network (e.g., the Internet). In step 1802, a technician may place a first network device in a building space and connect the network device to the Internet. In some embodiments, the technician may connect the network device to the Internet via cellular dongle 406 and/or Ethernet port 712. Connecting the network device to the Internet may cause the network device to act as a gateway to the Internet for other network devices.

In step 1804, the technician may place a second network device in the building space based on a signal strength. In step 1806, a technician may place a third network device based on a signal strength between the third network device and the second network device. Step 1806 can be repeated by a technician as many times as necessary, adding as many network devices as needed, to reach the building equipment 408. Each successive network device may be placed between the previously-placed network device and the building equipment 408 to extend the network closer to the building equipment 408. Network devices may be placed based on an indication of signal strength between network devices as indicated by an indicator on the network devices.

Although three network devices are used in this example, it is contemplated that any number of network devices can be placed or installed to reach the building equipment 408. In some embodiments, only one network device may be required (e.g., the first network device is within range of the building equipment 408). In other embodiments, two network devices may be sufficient to reach the building equipment 408. In other embodiments, three or more network devices may be installed to reach the building equipment 408. Each network device may connect to the previous network device installed and/or any other network devices within range.

In step 1808, the last network device installed, in this case the third network device, is connected to the building equipment 408. In step 1810, the third network device can facilitate communication between the third network device and the second network device, the second network device and the first network device, and the first network device and the Internet. Based on the chain of network devices, the building equipment 408 can be connected to the Internet. In some embodiments, the first network device, the second network device, and the third network device for a mesh network, wherein various paths for forwarding data packets can be formed. In various embodiments, the network formed by the network devices is start network typology, a bus network typology, a ring network topology, etc.

The present invention presents several advantageous. The wireless network may be installed as a temporary network which may later be integrated into the permanent network infrastructure of the building. This may increase the wireless network size and may enhance the reception in the building. Additionally, it removes the need to remove and reinstall a permanent network, thus reducing costs associated with installation and reinstallation of network devices. It also provides a way to configure the network to communicate before building equipment 408 has been installed, or to configured the network to communicate without it being necessary to configure the network devices to control the building equipment. Advantageously, the network may be installed, and the network devices may be later transitioned into control devices to control the building equipment. This enables greater flexibility in the installation of building equipment and network devices. Network devices may be easily added or removed which provides a network with greater flexibility to network changes or building device changes. Additionally, the network infrastructure is wireless, which enables the building equipment to wirelessly transmit information to a server, reducing the possibility of incorrect cable connections and reducing the need to install and re-install cables throughout the building. The present invention may also be used as a temporary wireless network, which may be used for testing the building equipment during the building construction phase. The temporary wireless network may then be integrated into the permanent building network, which may reduce costs associated with removing the temporary network and installing a new permanent network.

### Temporary to Permanent Network Switchover

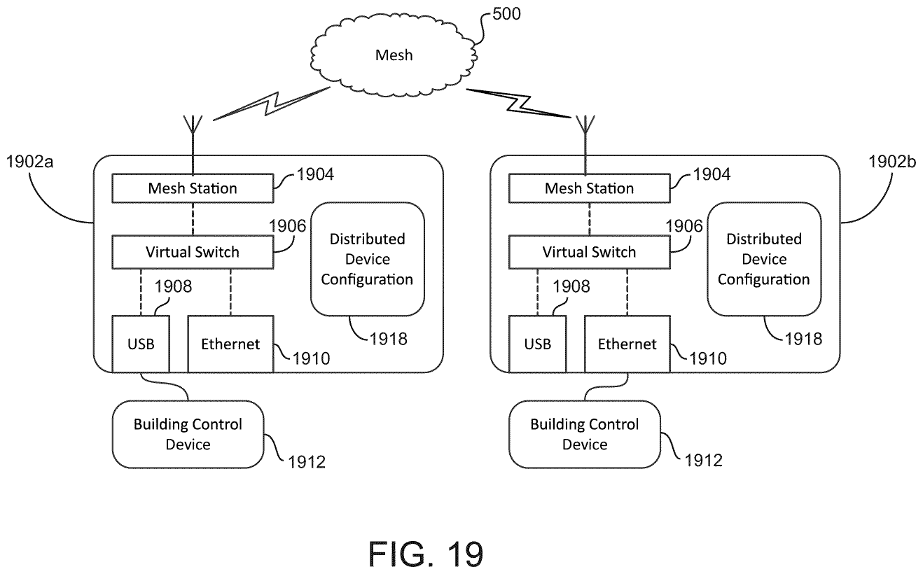

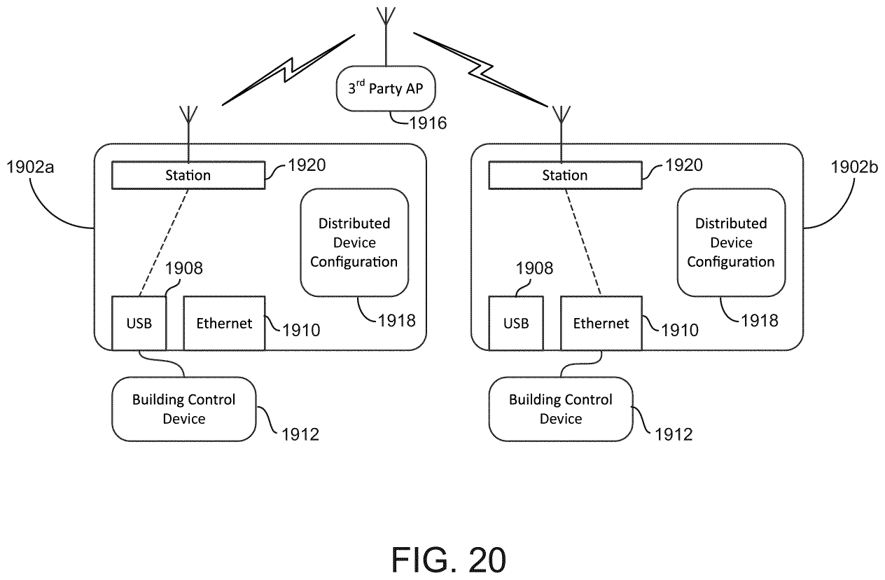

Referring now to FIGS. 19-20, various approaches to transitioning from a temporary building network to a permanent building network are shown, according to some embodiments. In some embodiments, the transition from the temporary building network to the permanent building network is facilitated by various software changes on devices which make up the temporary network. In some embodiments, transitioning from the temporary to the permanent building network is facilitated using a Distributed Device Configuration (DDC) mechanism 1918 as described in U.S. patent application Ser. No. 16/543,452, filed Aug. 16, 2019, the entirety of which is incorporated herein by reference.

Referring now to FIG. 19, network device 1902a and network device 1902b are shown communicably connected (e.g., defining, making up, being a part of, partially defining, partially making up, etc.) to mesh network 500, according to some embodiments. While only two network devices 1902 are shown, it should be understood that there may be more than two similarly configured network devices 1902 communicably connected to mesh network 500. In some embodiments, FIG. 19 demonstrates when mesh network 500 is in a temporary, first, or provisional state prior to an available building wireless infrastructure. In some embodiments, when network device 1902 is in the temporary state, a mesh station 1904 is bridge to one or both of a USB interface 1908 and an Ethernet interface 1910 using a virtual switch 1906.

In some embodiments, DDC 1918 provides a “Config/Auth” interface for easily specifying the authentication information necessary to join the building wireless infrastructure. In some embodiments, DDC 1918 synchronizes the “Config/Auth” interface to each of network devices 1902 to update their configurations.

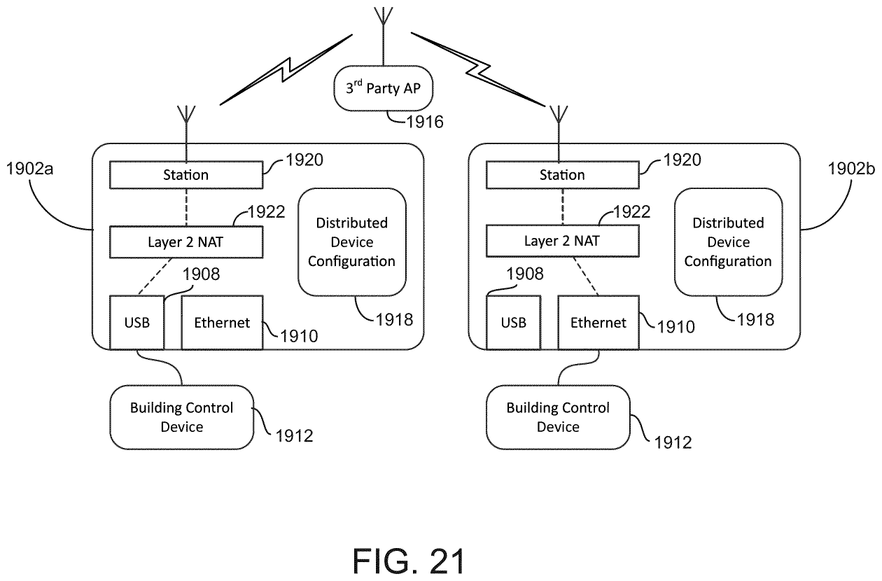

Referring now to FIGS. 20-21, network devices 1902a and 1902b are shown in the permanent or second state, according to some embodiments. In some embodiments, when the network is transitioned into the permanent state (e.g., switched to the building wireless infrastructure, communicably connected to third party access point 1916), configurations, profiles, operational characteristics, parameters, etc., of each of network devices 1902a and 1902b are updated. In some embodiments, the configurations of each of network devices 1902a and 1902b are updated by replacing mesh station 1904 with a standard 802.aa station interface (station 1920) and joining to the building wireless infrastructure using the authentication information originally provided in DDC 1918's “Config/Auth” interface. In some embodiments, virtual switch 1906 is removed. In some embodiments, the interface to which environmental control device, shown as building control device 1912, is attached (downstream interface) is virtually linked to station 1920's interfaces (e.g., USB interface 1908, Ethernet interface 1910) in one of several ways. A first way is by creating a virtual wire between one of USB interface 1908 or Ethernet interface 1910 and building control device 1912 so as to forward every data packet from the downstream interface to station 1920 and every packet from station 1920 to the downstream interface (e.g., USB interface 1908, Ethernet interface 1910). In some embodiments, station 1920 and building control device 1912 have a same MAC address. Another approach is to configure a layer 2 Network Address Translation (NAT) 1922 to join the IP address of station 1920 to a private IP assigned to building control device 1912, as shown in FIG. 21.

Referring generally to FIGS. 19-21, there are several challenges for using these features to transition from the temporary state to the permanent state, according to some embodiments. One challenge is that a standard access point to station communication does not allow for another device downstream of the station for multiple reasons. A typical access point needs only know about the stations connected to it, identified by MAC address, according to some embodiments. Therefore, when a packet arrives at the access point destined for a MAC address that is not one of its stations, the access point ignores the packet instead of forwarding it to the station to which the destination device is connected, according to some embodiments.

Additionally, a packet transmit from a station to a typical AP contains only one MAC address for the source/transmitting radio. This means that when the building control device 1912 sends a packet to the station to be relayed to the access point, the station replaces the source MAC address with its own MAC address, according to some embodiments. When the recipient of the packet somewhere on the network attempts to respond, it responds to the MAC address of the station and the packet may not arrive at the building control device 1912, according to some embodiments. Some systems that seek to address this problem (primarily by adding a second source MAC for use by wireless), require that both the AP and the station support it, according to some embodiments. Additionally, such implementations are not necessarily compatible with each other, according to some embodiments.

A virtual switch, therefore, cannot be attached to a station because the switch operates by forwarding messages to the correct port based on MAC address, according to some embodiments. Instead, using the virtual wire, the station is directly linked to the interface to which the building control device 1912 is attached, according to some embodiments. By using the direct link and forwarding every message, it is guaranteed that all packets are forwarded without interpreting the MAC addresses within, according to some embodiments. This can be thought of as “fusing” the two devices, according to some embodiments.

In order to resolve the problem described above regarding the original source's MAC address being overwritten by the station, the building control device 1912 and the station are forced to use the same MAC address, according to some embodiments. This does not cause a conflict because they are directly linked with no MAC address interpretation on the packet path between them, according to some embodiments.

An alternative to the virtual wire as shown in FIG. 20 uses a Layer 2 Network Address Translation (NAT) 1922 as shown in FIG. 21, according to some embodiments. This approach creates a one-to-one mapping between a IP address on the public side of the Layer 2 NAT 1922 (the IP of station 1920, which may have been provided by a DHCP server on the building wireless infrastructure) with an IP address on the private side of the Layer 2 NAT 1922 (the IP address of the building control device 1912), according to some embodiments. Layer 2 NAT 1922 updates the destination on every packet received by the station 1920 to point to the building control device 1912 and then forwards the packets on the downstream interface (e.g., USB interface 1908 or Ethernet interface 1910), according to some embodiments. The same occurs in the opposite direction: when the building control device 1912 sends a packet out, Layer 2 NAT 1922 updates the source address information to match the station 1920 and sends the packet out the station interface, according to some embodiments. The network device 1902 may configure Layer 2 NAT 1922 automatically to provide a seamless and transparent operation, according to some embodiments.

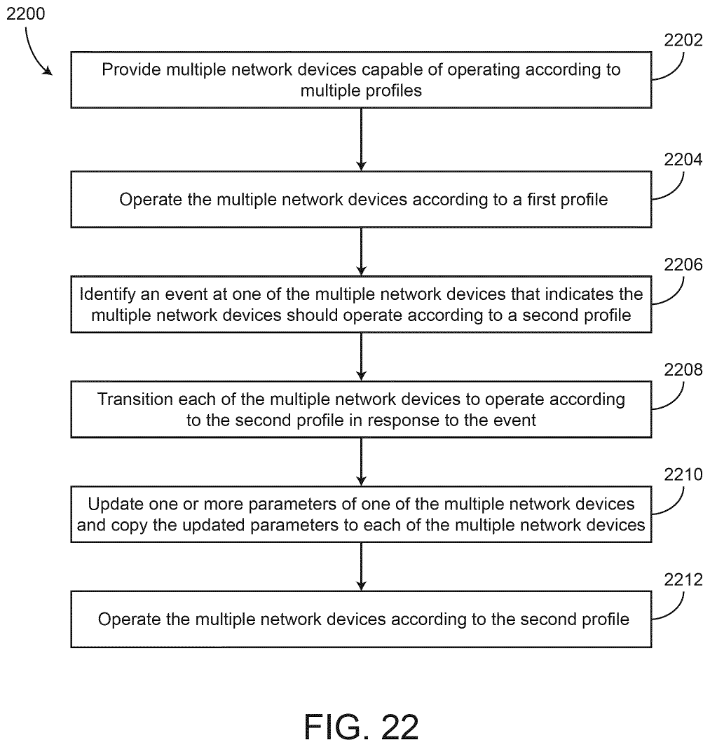

Referring particularly to FIG. 22, a process 2200 for transitioning multiple network devices between a first network architecture and a second network architecture is shown, according to some embodiments. In some embodiments, process 2200 includes steps 2202-2212 and can be performed for any of service network 400, mesh network 500, and/or any of the devices that make-up service network 400 or mesh network 500 (e.g., network devices 404). Process 2200 can be performed automatically or based on a user input to transition the network between a first topology and a second topology.

Process 2200 includes providing multiple network devices capable of operating according to multiple profiles, operational modes, personalities, etc. (step 2202), according to some embodiments. In some embodiments, the multiple network devices are positioned about a building and may be installed by skilled technicians. In some embodiments, each of the multiple network devices are capable of operating according to different profiles for different network topologies. For example, each network device may be capable of operating according to a first profile for a mesh network topology, a second profile for a client/access point network topology, a third profile for a bridge mesh network topology, and/or any other profile for any other type of network topology. In some embodiments, the multiple network devices are configured to operate according to the first profile for a first or stand-alone network topology (e.g., a “temporary network” topology) and a second profile for a second or permanent network topology.

The multiple network devices may be configured to store each of the multiple profiles in their respective memories. In other words, each network device may store multiple profiles concurrently. One of the profiles may be currently active (i.e., the device is currently operating according to the settings defined by the active profile) whereas the other profile(s) may be inactive (i.e., stored in memory of the network device but not currently being used to operate the network device). Each profile may include a set of parameters, configuration settings, or other information that enables the network devices to operate according to the corresponding network topology when that profile is active. For example, each profile may include profile-specific security keys, profile-specific SSIDs, whether or not the SSIDs are broadcasted, whether or not cellular connectivity should be enabled, whether any of the network devices 404 are bridge devices, etc. In some embodiments, one or more of the profiles stored by a network device may include placeholders for various parameters that are not yet populated within the profile. For example, a network device can be pre-loaded with multiple profiles including at least one fully-populated profile and at least one incomplete profile. The fully-populated profile may include values for all of the parameters needed to operate according to that profile, whereas the incomplete profile may lack values for one or more parameters needed to operate according to that profile. Alternatively, the incomplete profile may be populated with placeholder values to be replaced at a later time. The placeholder values or missing values of the incomplete profile can be provided to the network device while the network device is operating according to the fully-populated profile so that the incomplete profile becomes fully-populated before transitioning the network device to use the previously-incomplete profile.

Process 2200 includes operating the multiple network devices (e.g., in a mesh network topology) according to a first profile (step 2204), according to some embodiments. In some embodiments, the multiple network devices operate in the mesh network topology for a temporary or stand-alone building network (e.g., as shown in FIGS. 4-6). In some embodiments, the mesh network that is formed by the multiple network devices when operating according to the first profile is a self-sustaining or stand-alone network. In some embodiments, the multiple network devices may have a particular security policy that is less strict than a security policy used by the multiple network devices when operating according to the second profile. In this way, when the network devices operate as the stand-alone mesh network topology, the network devices may be more “open” while the network devices may be more “closed” when operating as the converged network. In some embodiments, the multiple network devices are configured to store configuration or network settings for each of the multiple profiles in their memory. In some embodiments, when the network devices operate according to the first profile, the network devices are configured to use mesh-specific security keys. In some embodiments, the network devices use mesh-specific SSIDs when operating according to the first profile. In some embodiments, the network devices are configured to broadcast their SSIDs when operating according to the first profile. In some embodiments, none of the network devices are configured as bridge devices when operating according to the first profile. In some embodiments, at least one of the network devices are configured to operate as a server (e.g., a DHCP server, a DNS server, etc.) when operating according to the first profile. In some embodiments, at least one of the network devices are configured to wirelessly communicate with a cell tower to provide Internet connection to other network devices in the mesh when operating according to the first profile. In some embodiments, none of the network devices use spanning tree protocol (STP) when operating according to the first profile (e.g., STP protocol is disabled).

Process 2200 includes identifying an event at one of the multiple network devices that indicates the multiple network devices should operate according to a second profile (step 2206), according to some embodiments. In some embodiments, the event is a command received from a user, a technician, etc., to transition the multiple network devices to operate according to another profile to achieve a different network topology. In some embodiments, the event is a loss of connectivity to an IT network that is detected automatically at one of the multiple network devices. For example, if the active network topology is a client/access point network topology and the access point device goes offline, the remaining devices in the network can automatically switch to a different profile (e.g., a mesh network profile) that allows the remaining devices to continue communicating with each other. In some embodiments, the network devices automatically switch back to the first network topology in response to detecting that the event triggering the transition is no longer active. For example, if the access point device comes back online, the remaining network devices may automatically switch back to the client/access point network topology.

Process 2200 includes transitioning each of the multiple network devices to operate according to the second profile in response to the event (step 2208), according to some embodiments. In some embodiments, transitioning each of the multiple network devices includes switching from using the configuration settings defined by the first profile to using the configuration settings defined by the second profile. In some embodiments, both the first profile and the second profile are stored in each of the network devices prior to beginning the transition. In this case, the transition may simply cause the network devices to switch from using one set of stored configuration settings to using another set of stored configuration settings. In other embodiments, the configuration settings needed to operate according to the second profile are not stored by one or more of the network devices prior to executing the transition (or placeholder values are stored for these configuration settings) such that an external input is needed to provide one or more of the network devices with the appropriate configurations settings to use when operating according to the second profile.

In some embodiments, transitioning each of the multiple network devices includes receiving configuration parameters at one or more of the network devices for other network devices. For example, the configuration parameters may be provided by the user or the technician at a particular network device, and transferred through the mesh network for the other network devices. In some embodiments, the network devices transfer or provide the configuration parameters to the various network devices in the mesh using techniques described in greater detail with reference to U.S. application Ser. No. 16/543,452, filed Aug. 16, 2019, the entire disclosure of which is incorporated by reference herein. In this way, each network device may store its own configuration settings and/or parameters in addition to storing configuration settings/parameters for any or all of the other network devices. In some embodiments, the user or technician may update one of the multiple network devices to operate according to the second profile, and the updated network device may copy its configuration settings to other network devices on the mesh network to transition the other network devices into the second profile. In some embodiments, the updated network device provides a notification, indication, etc., to the other network devices on the mesh network so that the other network devices transition into the second profile. In some embodiments, when the network devices are transitioned into the second profile, one or more of the multiple network devices are identified as bridge devices or access points and may have specific configuration parameters to function as bridge devices or access points. In some embodiments, the bridge or access point devices are pre-identified by a technician. In some embodiments, the bridge or access point devices are automatically identified or assigned.

Process 2200 includes updating one or more parameters or configuration settings of the multiple network devices and copying the updated parameters to each of the multiple network devices (step 2210), according to some embodiments. In some embodiments, the one or more parameters or configuration settings include different security keys, different SSIDs, whether or not SSIDs are broadcasted, whether or not any of the network devices are bridge devices, whether or not any of the network devices are server devices, whether or not any of the network devices are configured to communicate with a cell tower, and whether or not the network devices use STP protocol. In some embodiments, updating the one or more parameters or configuration settings of the multiple network devices includes updating the security keys, updating the SSIDs of the network devices, configuring the network devices so that they do not broadcast their SSIDs, configuring one or more network devices as bridge devices or access points, reconfiguring the network devices that operate according to the first profile as a server device so that such devices do not operate as a server device, disabling cellular connectivity on the one or more network devices, and enabling STP on any or all of the network devices. In some embodiments, step 2210 is optional. For example, each network device may already store parameters or configuration settings required for transitioning. In some embodiments, each network device include an inactive profile that is activated upon transition, and step 2210 is optional.

In some embodiments, the one or more bridge devices or access points are configured to establish communication with an IT network or a backbone network infrastructure (e.g., through a wired or wireless connection). In some embodiments, the other network devices may communicate with the IT network or the backbone network infrastructure through the one or more bridge devices or access point devices.

Process 2200 includes operating the multiple network devices according to the second profile (e.g., as a converged network) (step 2212), according to some embodiments. In some embodiments, the network formed by the network devices is merged with the IT network or the backbone network of a building to achieve the converged network. In some embodiments, the network devices other than the bridge devices or the access point devices are configured to communicate with the IT network or the backbone network through the one or more bridge devices or access point devices.

A process similar to process 2200 may be performed to transition the network devices out of the second profiles to the first profiles. In some embodiments, the bridge devices that communicate with the IT network or the backbone network of the building monitor a connectivity of the IT network. If the IT network fails, the process may be performed to transition the network devices back to the first profile so that the network devices may form a mesh network and communicate with a cell tower. The process may include performing steps 2204, 2208, 2210, and 2212 of process 2200 in reverse order. Advantageously, the network devices may transition between the converged network and the mesh network (e.g., the standalone network) by transitioning between the various profiles described herein and updating their configuration settings or operational parameters.

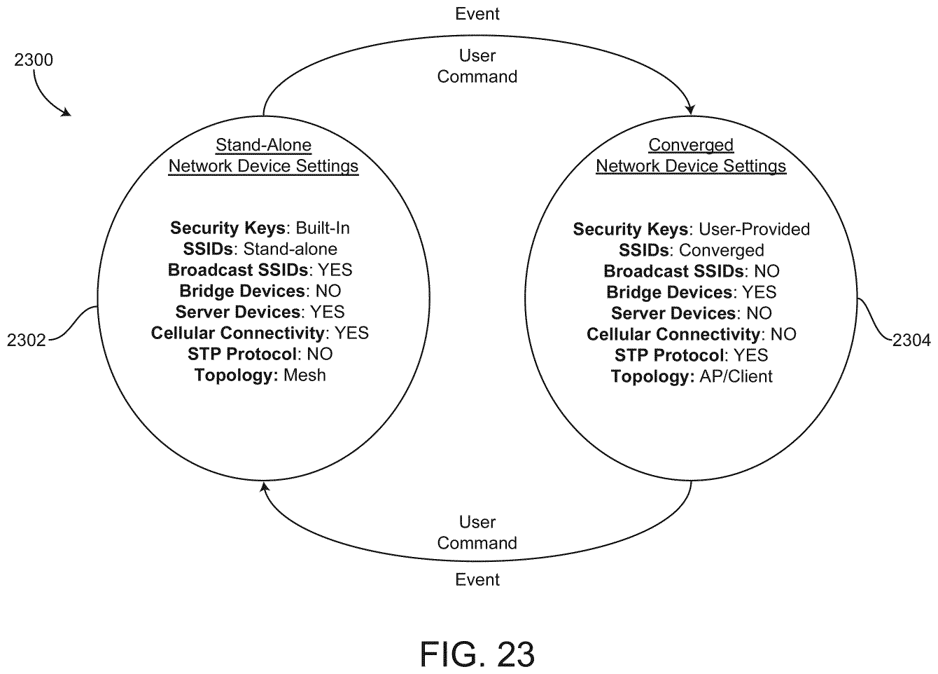

Referring particularly to FIG. 23, a state diagram 2300 shows various parameters of network devices 404 that may be updated, changed, reconfigured, overwritten, etc., to transition the network devices 404 between a first profile 2302 and a second profile 2304. In some embodiments, both first profile 2302 and second profile 2304 are stored in memory of the network devices (e.g., in memory 724 of network devices 404, in memory of communications processor 910 of controller/processor device 900, in memory of the communications processor 1504 of power adapter device 1500, in memory of network device 1902, etc.). In some embodiments, values of first profile 2302 or second profile 2304 are provided by a user or a technician when the changeover between first profile 2302 and second profile 2304 occurs. It should be understood that the description of the operating profiles and their associated parameters as described herein with reference to FIG. 23 may be used by any of network devices 404.

When the network devices 404 operate according to first profile 2302, the network devices 404 may form a mesh network. When the network devices 404 operate according to second profile 2304, the network devices 404 may form a converged network and one or more of the network devices 404 may function as bridge devices or gateways to establish communication with an IT network or a backbone infrastructure network (e.g., backhaul Ethernet 700) of a building (e.g., building 10) in which the network devices 404 are positioned. The network devices 404 may use built-in security keys and stand-alone SSIDs when operating according to the first profile 2302. In some embodiments, the network devices 404 use different security keys or different SSIDs when operating according to the second profile 2302. In some embodiments, the network security that results from the network devices 404 using the security keys when operating according to the second profile 2304 is stricter than the network security that results from the network devices 404 using the security keys when operating according to the first profile 2302. For example, when the network devices 404 operate according to the second profile 2304 in the converged network, the network devices 404 may use security keys or network security policies as set or determined by the building owner (e.g., a same network security as the IT network or the backbone infrastructure network of the building). When the network devices 404 operate according to the first profile 2302, the network devices 404 may use security keys or network security policies as determined by the installation company of the network devices 404 or by a manufacturer of the network devices 404. In some embodiments, the security keys used by network devices 404 when operating according to the first profile 2302 are built-in security keys, while the security-keys used by network devices 404 when operating according to the second profile 2304 are user-provided.

In some embodiments, when the network devices 404 operate according to the first profile 2302, the network devices 404 are configured to broadcast their SSIDs. In some embodiments, when the network devices 404 operate according to the second profile 2304, the network devices 404 do not broadcast their SSIDs.

In some embodiments, when the network devices 404 operate according to the second profile 2304, one or more of the network devices 404 function as bridge or gateway devices to establish communication with the IT network or the backbone infrastructure network to form a converged network. However, when the network devices 404 operate according to the first profile 2302, none of the network devices 404 function as bridge or gateway devices between the network devices 404 and the IT network. In this way, the network devices 404 may function as a mesh network that is self-sustaining and stands alone, regardless of whether or not an IT network is present in the building. Advantageously, the network devices 404 may be operated according to the first profile 2302 as a temporary network for the building. In some embodiments, during a changeover of the network devices 404 from the first profile 2302 to the second profile 2304, one or more network devices 404 are identified as bridge devices (e.g., by a technician or a user, automatically, or according to a predetermined selection) and the network devices identified as bridge devices are updated accordingly so that they can establish communication between the network devices and the IT network.

In some embodiments, when the network devices 404 operate according to the first profile 2302, one or more of the network devices 404 function as server devices. For example, one or more of the network devices 404 may be DHCP or DNS server devices. In some embodiments, when the network devices 404 operate according to the second profile 2304, the network devices 404 that function as server devices are reconfigured so that they do not operate as server devices.

In some embodiments, when the network devices 404 operate according to the first profile 2302, one or more of the network devices 404 are enabled for cellular connectivity. For example, some of the network devices 404 may be configured to wirelessly communicate with a nearby cell tower to provide Internet connection to the mesh network. In some embodiments, when the network devices 404 operate according to the second profile 2304, the cellular connectivity of the network devices 404 is disabled so that the network devices that form the converged network receive Internet access through the IT network or the backbone infrastructure network of the building.

In some embodiments, when the network devices 404 operate according to the first profile 2302, the network devices 404 do not use STP. In some embodiments, when the network devices 404 operate according to the second profile 2304, STP is enabled on the network devices 404. In some embodiments, the network devices 404 that function as bridge devices use STP communications when operating according to the second profile 2304.

In some embodiments, the network devices 404 form a mesh network topology when operating according to the first profile 2302. In some embodiments, the network devices 404 form an AP/client network topology when operating according to the second profile 2304.

In some embodiments, the network devices 404 are configured to transition between operating according to the first profile 2302 (e.g., to form a stand-alone mesh network) and the second profile 2304 (e.g., to form a converged network that is merged with the IT network or the backbone network infrastructure of the building) in response to a user command or in response to a detected event. For example, a technician may initiate a changeover process from the mesh network to the converged network or vice versa at any of the network devices 404 by reconfiguring the network device 404 to operate according to the first profile 2302 or according to the second profile 2304. In some embodiments, if one of the network devices 404 or a particular network device 404 is transitioned from operating according to the first profile 2302 to operating according to the second profile 2304, the other network devices 404 that form the mesh network may be updated by the transitioned network device 404. For example, the transitioned network device 404 may copy or clone its configuration settings to the other network devices 404 to transition the other network devices 404 from operating according to the first profile 2302 to operating according to the second profile 2304. In some embodiments, the changeover may be initiated by connecting one of the network devices 404 of the mesh network to the IT network or backbone network infrastructure of the building. If the network device 404 detects that it has been connected to the IT network or the backbone network infrastructure, the connected network device 404 may notify the other network devices 404 that a changeover has been initiated and the other network devices 404 may transition into operating according to the second profile 2304.

In some embodiments, the parameters of network devices 404 as shown in FIG. 23 may be defined, written, transitioned, adjusted, etc., by a technician. For example, the network devices 404 may store placeholders for any of the parameters described herein which may be later defined or written by a technician. When the technician transitions one of the network devices 404 out of the first profile 2302 to the second profile 2304, the transitioned network device 404 may receive its particular configuration settings from the technician. The transitioned network device 404 may provide its particular configuration settings to the other network devices 404 to transition the network devices 404 to operate according to the second profile 2304.

In some embodiments, when the network devices 404 operate according to the second profile 2304, one or more of the network devices 404 function as a bridge device between the IT network (e.g., backhaul Ethernet 700) and the network devices 404 to form the converged network. In some embodiments, the bridge device is identified by the technician or predetermined during changeover or transition of the network devices 404 from the first profile 2302 to the second profile 2304.

In some embodiments, the bridge device(s) are configured to monitor a connectivity or status of the IT network or the backbone network infrastructure. For example, the bridge device(s) may identify if the IT network or the backbone network fails. If the network devices 404 are operating according to the second profile 2304 and the IT network fails, the bridge device(s) may transition back into the first profile 2302, and notify the other network devices 404 to operate according to the first profile 2302. In this way, the network devices 404 may automatically transition between the first profile 2302 and the second profile 2304 in response to the IT network failing. Advantageously, if the IT network fails and Internet connection is lost, the network devices 404 may automatically reconfigure themselves to form a mesh network and obtain Internet connection via the cellular connection of one or more of the network devices 404. In some embodiments, the network devices 404 only automatically transition out of the second profile 2304 to the first profile 2302 if the IT network fails for a predetermined amount of time. In some embodiments, if the IT network fails for a predetermined amount of time, the network devices 404 may reconfigure themselves to operate according to the first profile 2302 to provide residents or occupants of the building with Internet connection.

Advantageously, the network devices 404 may operate according to the first profile 2302 during time periods of IT network failure or as a temporary network when the building is first constructed or under renovation. In some embodiments, when a building is first constructed or is under renovation, Internet connection is desired even before the IT network is installed. Network devices 404 may be installed prior to installation of the IT network and may function according to the first profile 2302 to provide Internet connection for workers, employees, residents, occupants, etc., of the building even before the IT network is installed in the building. After the IT network is installed in the building, the network devices 404 may be integrated into the IT network to form the converged network by being transitioned to operate according to the second profile 2304.

In some embodiments, the network devices 404 may be transitioned from operating according to the second profile 2304 to operating according to the first profile 2302 in response to a user command. For example, if the IT network will undergo maintenance, be replaced, etc., a technician may provide a user command to any of the network devices 404 to transition one of the network devices 404 from operating according to the second profile 2304 to operating according to the first profile 2302. The other network devices 404 may reconfigure themselves to operate according to the first profile 2302 in response to the user command provided by the technician. Advantageously, the network devices 404 can be automatically or manually transitioned between the first profile 2302 when a standalone network is desired and second profile 2304 when a permanent or converged network is desired.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A building network system for a building, the system comprising:
a plurality of network devices forming a network for the building, each network device of the plurality of network devices comprising:
a communications interface configured to communicate with other network devices of the plurality of network devices; and
a processing circuit storing a first profile comprising a first set of configuration settings that cause the network device to operate according to a first network topology when the first profile is active and a second profile comprising a second set of configuration settings that cause the network device to operate according to a second network topology when the second profile is active;
wherein the processing circuit is configured to transition the network device from operating according to the first network topology to operating according to the second network topology by deactivating the first profile and activating the second profile.

2. The building network system of claim 1, wherein the communications interface is or includes a wireless radio configured to wirelessly communicate with the other network devices of the plurality of network devices.

3. The building network system of claim 1, wherein the communications interface includes a wireless radio and an Ethernet interface and one or more of the plurality of network devices are wireless-Ethernet hybrid devices.

4. The building network system of claim 1, wherein the plurality of network devices are configured to form a wireless network for the building and transition between operating according to the first profile and operating according to the second profile automatically in response to a detected event or in response to a user command.

5. The building network system of claim 1, wherein the first network topology is a mesh network topology and the first set of configuration settings cause the network device to communicate with a cell tower using cellular communications when operating according to the first profile.

6. The building network system of claim 5, wherein the second set of configuration settings cause the network device to disable the cellular communications in response to transitioning to the second network topology and operating according to the second profile.

7. The building network system of claim 1, wherein at least one of the first profile or the second profile is a network profile comprising a plurality of device-specific profiles, each of the device-specific profiles comprising a set of configuration settings for at least one of the plurality of network devices, the device-specific profiles comprising at least a first device-specific profile for a first network device of the plurality of network devices and a second device-specific profile different from the first device-specific profile for a second network device of the plurality of network devices.

8. The building network system of claim 1, wherein the plurality of network devices are configured to use a first security policy when operating according to the first profile and a second security policy when operating according to the second profile, wherein the first security policy is a device manufacturer security policy and the second security policy is a security policy of an infrastructure network of the building.

9. The building network system of claim 1, wherein transitioning from operating according to the first network topology to operating according to the second network topology comprises causing one or more network devices of the plurality of network devices to operate as bridge devices between an infrastructure network of the building and the plurality of network devices;
wherein the one or more network devices that function as bridge devices are configured to monitor a status of the infrastructure network of the building and cause the plurality of network devices to transition back to operating according to the first profile in response to a detected failure of the infrastructure network.

10. The building network system of claim 1, wherein each network device of the plurality of network devices stores multiple sets of device-specific configuration settings within at least one of the first profile or the second profile, each set of the device-specific configuration settings corresponding to a different network device of the plurality of network devices and being used by the corresponding network device when the first profile or the second profile is active.

11. The building network system of claim 1, wherein the first set of configuration settings cause one or more of the plurality of network devices to operate as a dynamic host configuration protocol server or a domain name system server when the plurality of network devices operate according to the first profile.

12. A method for changing a network topology of a network, the method comprising:
operating a plurality of network devices according to a first profile to form a stand-alone network for a building;
detecting a trigger at one of the plurality of network devices to transition the plurality of network devices to operate according to a second profile;
reconfiguring each of the plurality of network devices to operate according to the second profile, wherein the plurality of network devices form a converged network with an infrastructure network of the building when operating according to the second profile; and
operating each of the plurality of network devices according to the second profile.

13. The method of claim 12, wherein at least one of the first profile or the second profile is a network profile comprising a plurality of device-specific profiles, each of the device-specific profiles comprising a set of configuration settings for at least one of the plurality of network devices, the device-specific profiles comprising at least a first device-specific profile for a first network device of the plurality of network devices and a second device-specific profile different from the first device-specific profile for a second network device of the plurality of network devices.

14. The method of claim 12, wherein the plurality of network devices are configured to use a first security policy when operating according to the first profile and a second security policy when operating according to the second profile, wherein the first security policy is a device manufacturer security policy and the second security policy is a security policy of an infrastructure network of the building.

15. The method of claim 12, wherein reconfiguring each of the plurality of network devices to operate according to the second profile comprises causing one of more network devices of the plurality of network devices to operate as bridge devices between an infrastructure network of the building and the plurality of network devices and the method further comprises:
monitoring a status of the infrastructure network of the building at the network devices that operate as bridge devices and causing the plurality of network devices to transition back to operating according to the first profile in response to a detected failure of the infrastructure network.

16. The method of claim 12, wherein each network device of the plurality of network devices stores multiple sets of device-specific configuration settings within at least one of the first profile or the second profile, each set of the device-specific configuration settings corresponding to a different network device of the plurality of network devices and being used by the corresponding network device when the first profile or the second profile is active.

17. A method for changing a network topology of a network, the method comprising:
providing a plurality of network devices configured to operate according to a first profile and a second profile;
operating the plurality of network devices according to the first profile to form a stand-alone network for a building;
transitioning the plurality of network devices between the first profile and the second profile; and
operating the plurality of network devices according to the second profile to form a converged network with an infrastructure network of the building.

18. The method of claim 17, wherein the plurality of network devices are transitioned between the first profile and the second profile automatically in response to a detected event or in response to a user command.

19. The method of claim 17, wherein at least one of the first profile or the second profile is a network profile comprising:
a plurality of device-specific profiles, each of the device-specific profiles comprising:
a set of configuration settings for at least one of the plurality of network devices, the device-specific profiles comprising at least a first device-specific profile for a first network device of the plurality of network devices and a second device-specific profile different from the first device-specific profile for a second network device of the plurality of network devices.

20. The method of claim 17, wherein transitioning the plurality of network devices from the first profile to the second profile comprises causing one or more network devices of the plurality of network devices to operate as bridge devices between the infrastructure network of the building and the plurality of network devices.
